(19) United States
(12) Patent Application Publication
(10) Pub. No.: US 2021/0038970 A1
(43) Pub. Date: Feb. 11, 2021

(54) LOTTERY USING SMALL POOL OF SYMBOLS

(71) Applicant: L2W LIMITED, Onchan (IM)

(72) Inventor: John Anthony REID, Upper Hutt (NZ)

(21) Appl. No.: 16/967,818

(22) PCT Filed: Feb. 5, 2019
(86) PCT No.: PCT/NZ2019/050008

§ 371 Date: Aug. 6, 2020

(30) Foreign Application Priority Data
Feb. 7, 2018 (NZ) 739727
Apr. 4, 2018 (NZ) 741302

(51) Int. Cl. A63F 3/06

(52) U.S. Cl. CPC A63F 3/061; A63F 3/0665

(57) ABSTRACT

A set of printed lottery cards using a symbol pool of from 6 to 16 symbols, in this example 9 symbols to be randomly drawn at the end of the lottery. Each card has two matrices of 3×3 cells each displaying a set of 9 differing symbols on each card, and has an area for recording the sequence of the numbers drawn, and an area for recording the total number of links achieved across the two matrices. This example shows the resulting links on each matrix after all numbers have been drawn. By printing two or more matrices per card, the total of number of links per card is additive but the number of possible permutations increases dramatically. These cards can be printed on demand at State Lottery retail outlets or pre-printed and used as “scratch and win” cards.

### FIELD OF THE INVENTION

The invention relates to a set of cards for a lottery using a small symbol pool. In practical terms this will be a small number pool as numbers are the preferred symbols for use in lotteries. The invention can be compared with lotteries known as “Lotto” or “Keno”.

### BACKGROUND OF INVENTION

Lotto/Keno type games are popular and were previously played with printed cards or tickets displaying an array of numbers which, during the draw, are selected randomly and called out or displayed on a screen so that players can see if they have one or more selected numbers on their card or cards. Today this effect is typically simulated on an electronic display screen where the electronic equivalent of a Lotto card is played. This class of games requires the player to select a small group of numbers from a larger pool. For example in a typical Keno game the payer selects between 4 to 10 entry numbers (depending on what Keno game the player wants to play) out of a pool of 80 available numbers, with the selected entry/game being resulted by the random draw of 20 numbers out of the 80. Given the size of the number pool the player engagement is limited as it is highly likely that numbers other than those selected by the player are drawn early in the lottery and overall most of the players will only see very modest levels of successfully matching their entry numbers with the numbers drawn.

Over recent years, in many of the world's mature “lotto” markets, participation in lotto offerings by government sanctioned and or owned lotteries (“State Lotteries”) has been relatively static or even declining. For example, in 2015, total US State Lottery sales were US$73.9 billion, but for the year ended 31 Dec. 2017, total US State Lottery sales were down to US$72.8 billion, a decline of 1.5% during this 2 year period. [Source: North American Association of State and Provincial Lotteries (“NASPL”)].

There are a number of reasons for this, including: a decline by natural attrition of lotto players; alternative gambling options, including more exciting interactive gaming over online channels; low uptake levels of traditional draw games by the younger generation (as traditional draw games are often considered by them as unexciting); and lack of draw game innovation, including in respect of both lotto and keno type draw games.

Big prize draw games (such as the well-known multi jurisdictional draw games of EuroMillions and American PowerBall) remain popular and receive significant support, more so as the size of the jackpot reaches its top levels:
in the case of EuroMillions: this is set at €190 million (at which point the game rules (as at February 2019) require that it be awarded and shared amongst lower division winners if not otherwise won);
in the case of American Powerball: there is no such ceiling, with jackpots often reaching dizzy heights well in excess of US$500 million and attracting a lot of betting interest (with the biggest Powerball win being US$1,586,000,000 in January 2016).

These high prized draw games capture the imagination of the general public. However, despite this, many state lottery operators are still experiencing some levels of declining revenues, primarily as a consequence of shifts in player preferences towards more engaging games with high churn delivering instant and engaging gratification, many of which can be accessed and played using other ‘online’ operators. Of note, in the United States, instant games comprise 60% of all US State Lottery sales. This can be compared to draw game sales of about 19% (comprised of American PowerBall (c. 10%), Keno (c. 5%) and individual state lottos (c. 4%).(Source: North American State and Provincial Lottery Association, 2017 figures for US Lottery Sales).

Nevertheless, State Lotteries core products are their scheduled draw games. These are primarily distributed through land-based retail networks that have been steadily built up over multiple decades, and must be considered as one of the main core assets of all land based/retail focused State Lotteries.

### Basic Draw Game Construction

At its most basic level, existing draw games are based on an entry comprising a small number set being selected from a much larger number pool, and then attempting to match the entry numbers (in any order) against a separate random draw of some of the numbers from the total pool, with such random draw usually being: for Lotto, of the same size as the number of numbers in an entry; for Keno: of a greater size as Keno draws 20 numbers from 80 to result its games.

### Lotto Draw Games—Game Construction

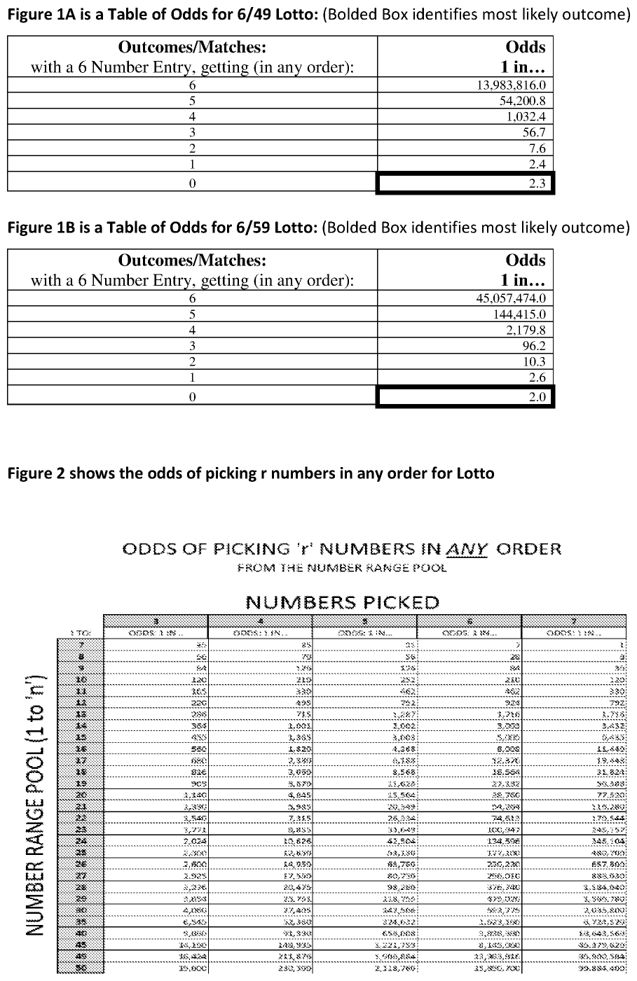

As an illustrative example, 6/49 lotto is a common and standard lotto game. It has top odds (i.e. the probability of a player correctly matching all 6 drawn numbers to their entry numbers) of 1 in 13,983,816 and its game play involves matching a player's 6 entry numbers chosen from the 49 number pool (in any order) against 6 subsequent randomly drawn numbers, drawn from the full 49 number pool. All the odds outcomes from this 6/49 game are set out in the table of FIG. 1A.

As can be seen from FIG. 1A, and as is typical for all recognised lotto games, most of the time players will experience very little engagement from achieving successful matches or results. In this 6/49 lotto, the odds of getting a nothing result (0 matches) is a very likely outcome, having odds of 1 in every 2.3 games (which is 41% of the time). Likewise, the odds of getting just one (1) match is also very likely to occur, at 1 in every 2.4 games. Combined, the overall odds of getting either nothing or one (0 or 1) matches in this lotto game occurs every 1 in 1.2 games, or in percentage terms about 85% of the time. Accordingly, player engagement or excitement in a standard 6/49 lotto game can be considered to be generally very low. As can be seen from FIG. 1B, the outcomes are similar with the 6/59 lotto game, but with the odds of getting a nothing result (0 matches) being even more likely, having odds of 1 in every 2.0 games (which is 50% of the time).

Changes can be made to this 6/49 game set out in FIG. 1A to alter its odds and outcomes, for example by increasing the number of required entry numbers, from 6 to 7 or 8. This would decrease the top odds from 1 in 13 million to 1 in 85.9 million and 1 in 451.0 million respectively, but it would no longer be a 6/49 lotto game. Instead it would be a new base lotto game of 7/49 or 8/49. Moreover, increasing the required entry numbers of any lotto game to 7 or 8 has the general disadvantage of increasing the numbers that players have to deal with and that players have to successfully get (to win the top prize) and it can also adversely affect players ‘perception’ of winnability as compared against using a smaller number of entry numbers (say 5-6).

While smaller entry numbers have advantages, they also have disadvantages. The use of smaller entry numbers (of say 5 or 6) from a single pool standard lotto game: (i) often creates restrictions on the size of the top prizes that can be offered, unless the size of the number pool is very high (due to the relatively high odds of a player attaining a high match rate); and (ii) creates problems with the ability to configure a prize pay-out table that has a sensible increasing non-win and win ladder and which generates engaging outcomes for players.

### Top Odds Considerations

To illustrate this top odds matter further (odds arising from the number of entry numbers Vs the total size of a single number pool), FIG. 2 shows the top odds for a range of entry numbers (3-7) when selected from a single number pool (ranging in size from just 7 up to a maximum of 50 numbers).

### FIG. 2

As can be seen from the table in FIG. 2, selecting 5 or 6 entry numbers from a pool of 50 numbers only results in top odds of 1 in 2.1 million or 15.9 million respectively.

Therefore to create a lotto game with relevantly high top odds/prizes for a sizable State Lottery using one single number pool (without any multipliers or other enhancements) and in order to maintain player entries at no more than 5 or 6 numbers (and leaving aside altogether for the moment issue (ii) noted above), the size of the single number pool would likely need to significantly increase beyond 50 numbers (depending on game application/top prize and entry fee requirements/size of intended market).

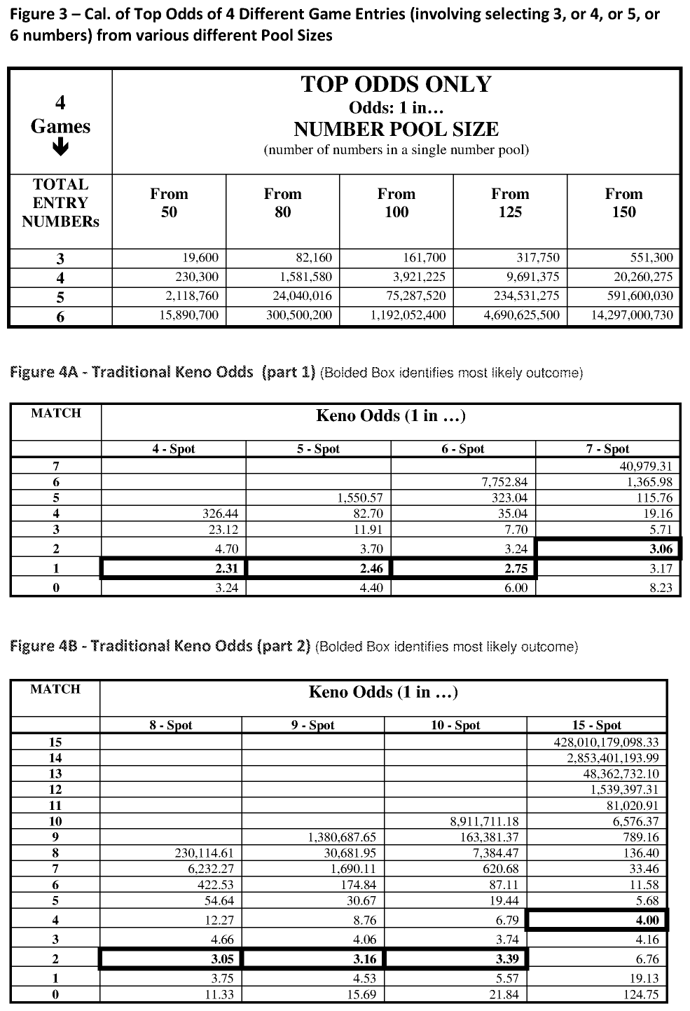

FIG. 3 shows a table setting out the top odds of four game configurations involving total entry numbers of 3 or 4 or 5 or 6, with such entries each being selected (and top odds calculated from) each of the following number pools: 50, 80, 100, 125 and 150.

From FIG. 3, certain general propositions applying to lotto games involving a single number pool can be distilled, based on the assumption that, for the game to be viable for the operator to run, the “top odds” associated with that game need to be below a certain probability. Thus, as a general proposition, a game with:

4 entry numbers is likely to need a very large pool of numbers, potentially 125-150 or more;

5 entry numbers is likely to need a lesser pool size, potentially of around 80-100 numbers; and 6 entry numbers is likely to need a pool size of around 50-80 numbers.

### Entry Number Considerations

On top of this ‘top odds’ limitation as discussed above, in base lotto games with only 5 or 6 entry numbers, the ability to configure a prize pay-out table that has a sensible increasing non-win and win ladder and which generates engaging outcomes for players is, at best, challenging.

From the 5 or 6 events, there must be allocations for non-winning events as well as for winning ones. As a result, there are often not enough Incremental Success outcomes for players to experience (even when non-winning), and in respect of the winning outcomes, there are not enough winning ‘steps’, ‘events’ or ‘outcomes’ to create good allocations for both minor prizes and a top prize, all combined in a manner that creates for an engaging and successful game.

Increasing the number of entry numbers goes some way towards addressing this problem by increasing the number of events, but this then introduces other problems as has been discussed.

### Features to Increase the Number of ‘Steps’, ‘Events’ or ‘Outcomes’

It would be preferable in single entry single pool lotto games if the number of ‘steps’, ‘events’ or ‘outcomes’ in a 5 or 6 number entry could be increased in an easily understood way while still using only a single number pool with the game resulted by one random draw.

There are some ‘imperfect’ ways to do this, but they are not widely adopted by operators as they can be confusing for players, and potentially disengaging for players (as can be seen from the following). As an illustrative example, and using the standard 6/49 lotto game, an extra “bonus feature” can be inserted, as described below:
(a) Players select 6 entry numbers from the 49 number pool and in addition they also select an additional (7^{th}) number from the remaining 43 numbers (here and for ease, called the “bonus number”);
(b) Then, after the operator has drawn the first 6 numbers for the main 6/49 lotto draw, the operator then continues the draw and draws one further number from the remaining 43 pool numbers, as the “bonus number”. HOWEVER, this extra event is in reality an extra draw, but from which many of the players will be eliminated prior to it even occurring;
(c) the odds of correctly achieving the “bonus number” can be used to increase the number of ‘steps’, ‘events’ or ‘outcomes’ in the base 6/49 lotto game, but it is an extra step inserted to alter the underlying base game.

In essence, in the foregoing described method of using an extra “bonus feature”, the player is selecting two entries: one comprised of 6 numbers; and the other entry of just 1. The first set of 6 entry numbers are resulted by a random draw from a perfect and complete pool (of 49). However, the second entry of 1 number is resulted afterwards, from an imperfect and incomplete pool (the remaining 43 pool numbers, the make-up of which is unknown at the start and only becomes known after the draw of the first 6 numbers). This means that many players in the draw game, that have as their selected “bonus number” a number that is drawn when resulting the main 6/49 lotto entry, are eliminated from the “bonus number draw” before the second stage draw even starts, which is not desirable. Further this process (and outcome) can be difficult to explain to players.

For reasons canvassed, it is difficult, if not impossible, to ‘innovate’ for a successful new single pool base lotto game involving a single entry of just 4-6 entry numbers from a number pool that is not excessive in total numbers, because of the constraints presented by: (i) the limitation on the number of outcomes (4-6); and (ii) the mathematical odds of the outcomes. In any event any such ‘innovation’ is likely to only be a reshuffle involving the size of the numbers required in an entry and the total size of the pool numbers and accordingly, such would unlikely be an innovation, but rather a new game configuration.

### Use of Two Separate Number Pools

To overcome some of the inherent difficulties in lotto game design that use a single number pool, some lotto games have been designed with the use of two number pools from which players choose two sets of numbers as comprising their entry. These games are resulted by the use of two random draws, one each in respect of the entry numbers chosen from each relevant pool.

The second number pool is usually smaller than the first, from which players select fewer entry numbers than from the first. In Lotto, it is often categorized as relating to the “power ball” or “bonus ball” number/s.

Importantly, the use of two separate number pools with entries from each provides extra ‘steps’, ‘events’ or ‘outcomes’ with more prize winning events overall to create for more engaging games. Further, each number pool is usually of a size that is lower than what would be required when creating similar top odds from a single number pool, thereby acting to potentially reduce any adverse ‘perception’ issues that some players may have relating to the otherwise alternative requirement (so as to achieve the same top odds) of using a much larger headline total number pool when using only a single pool of numbers.

In summary, the use of two number pools improves the performance and engagement of lotto games (compared to single pool games) as it: allows for greater manipulations of all the outcomes providing greater design flexibility; increases overall outcomes and prize winning opportunities thereby increasing player engagement; allows for better minimum winning odds than may otherwise be attainable, and each pool acts in concert to multiply up the top odds and top prize winning opportunities.

Examples of such games are the well know multi jurisdiction cross-sold lotto games of EuroMillions and American PowerBall, which each use two main pools. These two games are summarized in Table 1:

TABLE 1

| | EuroMillions | |
|---|---|---|
| | (sold by 9 European | American PowerBall |
| Lotto Game Data | Countries, incl. UK) | (sold by 44 US States) |
| Number of Main Pools | 2 | 2 |
| Entry from 1^{st} Number Pool | 5/50 | 5/69 |
| Entry from 2^{nd} Number Pool | 2/12 | 1/26 |
| Total Numbers Involved in Draws | 62 | 95 |
| Minimum Winning Odds | 1 in 13.0 | 1 in 24.9 |
| No of Prize Winning Events | 13 | 9 |
| Top Odds | 1 in 139,838,160 | 1 in 292,201,338 |
| Top Prize Restrictions | Limited to €190M | Not Limited |
| Top Prize - Biggest Win | €190,000,000 | US$1,560,000,000 |

EuroMillions and American PowerBall are examples of two differently designed and targeted multi jurisdictional cross-sold games. As can be discerned from Table 1:
i. Each game, has 2 main number pools (although American PowerBall has a 3^{rd} pool of up to 43 numbers that when invoked, is used as a multiplier of lower tier prizes), has been designed differently, producing different outputs;
ii. EuroMillions is designed for lower top prizes and more frequent minor prize payouts, with minimum winning odds, at 1 in 13;
iii. American PowerBall is designed for much higher top prizes with less frequent minor prize payouts, with minimum winning odds, at 1 in 24.9;
iv. Each game uses 5 entry numbers in respect of its 1^{st} number pool;
v. Both main number pools are comprised of less than 70 numbers, yet with the use of two entries from 2 number pools, low top odds are produced, at 1 in 140 million for EuroMillions and 1 in 292 million for American PowerBall. This can be compared against an alternative game option using a 5 number entry from a single pool of 100 numbers, which produces top odds of a far greater size, at 1 in 75 million (see FIG. 3), but as discussed earlier, such a single pool game involving 100 numbers can be considered by many players as ‘huge’ and can wrongly be ‘perceived’ by players as much harder to win, when in fact it is much easier to win than both of EuroMillions and American PowerBall;
vi. EuroMillions uses 2 entry numbers from its second pool (instead of just the 1 number as used by American PowerBall);
vii. EuroMillions game design results in 13 prize-winning events, whereas American PowerBall has 9.

As is typical for all recognised lotto games, most of the time both American PowerBall and EuroMillions players will experience very little engagement from successfully achieving matches with their entry numbers, as the combined odds or chances of getting nothing or just one match (0-1) (when using entry numbers that comprise just 5 or 6 numbers), are very likely outcomes. What drives repeat play from these players is being in with the chance to win the enormous top prize.

Notwithstanding, it would be preferable to provide within such lotto draw games, randomly produced outcomes that act to increase the players overall engagement, including by increasing the number of Incremental Successes and close or near wins, with such being experienced more often than currently occurs within most recognised lotto draw games.

### Keno Draw Games—Game Construction

Keno draw games have better levels of engagement than typical recognised lotto games.

FIGS. 4A and 4B illustrate tables showing the traditional Keno odds for a standard 80 number Keno game, where Players select the number of numbers they wish to play as an entry (called “Spots”) out of a single pool of 80 numbers. FIGS. 4A and 4B show 4-Spot Keno through to 10 and 15-Spot Keno (although by far the more frequently offered and or played Keno games are 4-10 Spot games, with the popular 10-Spot Keno having top odds of 1 in 8.9 million.

Keno game/s are resulted by the relevant gaming operator drawing substantially more numbers from the 80 number pool than the number of Spots being played by the player as his/her entry. The Operator always draws 20 numbers from 80 irrespective of the number of Spots being played, and the player matches his/her chosen number of Spots in any order against the 20 numbers drawn by the operator. This feature of drawing substantially more numbers than are contained on an entry results in more matches occurring and provides for stronger levels of player engagement when compared to a typical lotto game, with the most likely outcomes for each Keno game/entry usually being at least 2 matches, which is achieved for 7-Spot through to 10-Spot Keno games. The most likely outcome for each Keno game identified in FIGS. 4A & 4B is identified by a black box placed around the relevant outcome, which is also bolded.

As can be seen from FIGS. 4A & 4B, outcomes involving players getting nothing (0 matches) to 1 match, still occur fairly frequently, however such 0-1 matching outcomes in Keno games occur less frequently that what occurs in a typical lotto game.

Like lotto games, the above Keno games can have their outcomes altered by the use of additional entries (such as with bonus numbers or multipliers). For example, such as with using an additional entry from another number pool of say 10 or 20 numbers, and players picking a “bonus” (multiplier) number. Again, like in lotto games, the use of such multipliers usually affects all outcomes infrequently (say 1 in 10 games or 1 in 20 games as the case may be) and in the same way, and also results in extra ‘steps’, ‘events’ or ‘outcomes’ with more prize winning events and engagement overall.

### Lack of New Draw Game Innovation

In an industry where ‘other’ new gaming options and innovations are continually being undertaken and or sought, and in circumstances where draw games have been experiencing (to varying degrees): long-term pressure from other emerging (and more engaging) gaming options, such as online interactive gaming; growth rates that are generally below many other forms of comparable gambling, and in some cases draw game sales declines; and an increasingly aging player base with difficulties in attracting younger players, it could be initially considered to be somewhat surprising that there has been little to no new draw game innovation (beyond just changing the matrix configuration/s of existing draw games and or introducing add on features, such as extra bonus draws or prize multipliers).

However, the lack of actual draw game innovation cannot be said to be because there is a lack of attention given by the lottery industry to the subject of and need for draw game innovation, as innovation and the need for it are common and top of mind issues, especially as many State Lotteries are experiencing levels of comparatively poor to even negative growth rates compared with other gaming forms. Illustrative of this is the 1.5% decline in all US State lottery sales that occurred between 2015 and 2017.

This lack of draw game innovation can be explained with reference to and consideration of the issues that would need to be addressed and solved, which are both numerous and not easy. Further, the issues are often intertwined to the extent that the majority, if not most or all of the issues, all need to be solved in order to achieve any new successful draw game innovation of the type that is new and different to and beyond just changing the matrix configurations of existing draw games and or adding one or more new add-on features (such as an extra random drawing of some extra weekly ‘millionaire’ winners from the pool of entries in the underlying base lotto game, or adding a new or further bonus number/draw).

### Considering Changes That Have Occurred to American PowerBall

American PowerBall is a good example to consider what type of draw game design changes are made in order to meet different outputs as a lotto game matures and evolves in order to meet increasing player numbers and top prize requirements.

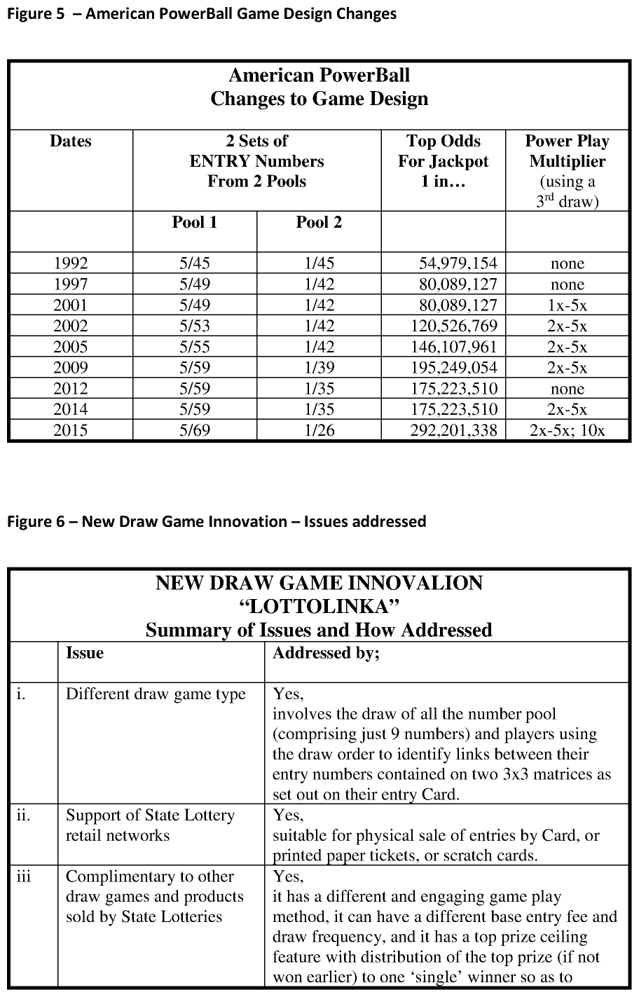

FIG. 5 overviews the ‘evolution’ in the underlying matrix designs and changes and the additional add on features that have occurred with the American PowerBall game from its first launch in 1992 (prior to this date the game was first known as Lotto America from an original launch in 1988) to present day. As can be seen in FIG. 5, the evolution centres around changes to the composition of the size of the two pools used, and in addition, changes with adding, changing or deleting lower tier prize multipliers using a third draw (the “Power Play Multiplier”). Of note is that the changes described below have been undertaken in a way so that consistency with retention of the core number of numbers used in the entry has remained the same from 1992 to the present day (February 2019), with “pick 5” and “pick 1” always being retained, while at the same time decreasing top odds (thereby correspondingly allowing greater prizes) to meet the necessary requirements and outputs arising from the game's growth.

The Power Play Multiplier used in American PowerBall was first introduced in 2001. When activated, it multiplies lower-tier winnings by up to 5×, or by up to 10× when the jackpot is under US$150 million. It also automatically doubles the 5+0 prize from US$1 million to US$2 million.

The Power Play Multiplier is drawn separately from the other two draws involving 5/69 and 1/26, so it involves a third draw, with such third draw being from a third pool of numbers. This third pool has varied in size from 30 to 43 numbers. It currently uses 42 numbers when multipliers are up to 5×, and 43 numbers when the 10× multiplier also applies.

As the game and player numbers have progressed, and to achieve the required outputs, the game's designers have had to increase the size of the main number pool, from initially 5/45 to what is currently now used, 5/69, (being an increase by 24 additional numbers).

Offsetting this 24 number increase, and in what appears at first glance to be a significant counter balancing decrease, there is a reduction in the size of the secondary number pool, from initially 45 numbers down to 26 (a reduction of 19 numbers). Accordingly, as the net difference over the two pools is only a net increase of 5 numbers, such a small net change can be perceived overall by many players as being slight and having little or inconsequential effect to the chances of winning. However such a perception is very wrong mathematically, as the corresponding outputs arising from the changes alter the top odds from 1 in 55 million to 1 in 292 million.

All the same, the changes in American PowerBall represent changes merely to the matrix configurations of the game, from 5/45 and 1/45, to 5/69 and 1/26, as opposed to there being any fundamental new draw game innovation.

### Issues to be Addressed in Any New Draw Game Innovation

In any new draw game innovation, issues to be addressed and solved should preferably include:
i. Different Draw Game Type: deliver a different draw game type with a different experience that is simple and transparent and which can be easily understood (following an introduction and education process) and for such NOT to be another rehash of a lotto or keno type draw game;
ii. Support of State Lottery Retail Networks: be capable of utilising and supporting the important retail network assets of State Lotteries, where the player entries in respect of any such new draw game are made by sale of physical entry cards, or scratch cards or dispensed paper tickets;
iii. Complementary: be created so that it can be positioned differently and complementary to the other draw games and products of State Lotteries;
iv. Low Entry Numbers And Low Pool Size: operate with low entry numbers and a low number pool as high entry numbers and number pools containing a large set of numbers can adversely affect player perceptions of winnability;
v. Increased Base Game Outputs: provide increased levels of Base Game Outputs (i.e. a greater number of possible game outcomes) of a level that is materially greater than comparable Base Game Outputs from recognized Base Game Structures of Lotto and Keno games used in comparable applications (for example 6/49 lotto without add-ons) and for such greater level of Base Game Outputs to be at levels sufficient to provide for a number of allocations for both non-winning and winning events, with such outputs having mathematical properties: that support higher levels of player engagement (provable mathematically on the odds); and which can be used to support well-constructed multi-level prize winning outcomes;
vi. Increased Range of Incremental Successes: deliver from any new Base Game Structure an increased range of easily understood Incremental Success achievements;
vii. Mathematically Provable Increased Engagement: deliver random outputs that can be proven mathematically to have increased levels of engagement for players from the Incremental Successes (which are important for non-winners) with such being compared to existing and comparable recognised lotto and or keno draw games.
viii. Provable and Frequent Wins of Top Prizes: address perceptions of non-winnable top prize/s in situations of low to medium player liquidity with a game play that provides for mathematically provable and frequently occurring wins of the top tier prize/s;
ix. High Top Odds: provide for high top odds capability that can be used both in high or low liquidity applications, without adversely affecting the overall game deliverables involving mathematically provable and frequently occurring wins of the top tier prize.

Preferably, it would also be beneficial to avoid the dilution of the top tier cash prize to multiple lower tier winners, which often occurs in circumstances where the jackpot reaches a ‘must win’ situation and no top tier winner emerges in the relevant draw, such as occurs with the EuroMillions jackpot once it reaches its €190,000,000 ceiling level and is not otherwise won.

Preferably, it would also be beneficial to minimise the number of different pools and draws, preferably, for each relevant game, to just one pool size and to one draw to result each game or in the event that two pools are required to be used, then such pools are low in number size, preferably containing less than 16 numbers each, preferably no more than 9 numbers each.

As can be seen from the above, the issues are numerous and complex, and some run counter intuitive to others. For example, and using ‘traditional thinking and logic’ that can be applied in draw game design, it is counter intuitive to have lower entry numbers and a lower pool size (which can help with player perceptions of winnability) while at the same time achieving increased outputs and outcomes, outputted by an underlying single base game from one number pool and one draw. The counter intuitive nature of this can be seen by reference to the matrix of odds discussed in the examples.

### RELATED INVENTIONS

Our WO2016/042489 patent family describes earlier versions of our lotteries based on links between adjacent cells in a 5×5 matrix as the symbols on the matrix are drawn at random.

Our WO2016/042490 patent family describes the mapping technology for displaying a 5×5 matrix and displaying and scoring the number of links as a result of a random draw. (Note that the term “our” in this specification refers to earlier patent families in which the present inventor is also the inventor or a co-inventor, or which is owned by L2W Limited, or LMS Patents (Isle of Man) Limited).

### PRIOR REFERENCES

W W Wiperi in GB1,604,303 (1978) teaches how to guarantee a single winner by using a set of cards made up of all of the possible permutations of available numbers. This however still requires a large number of numbers to be drawn before a winner can be declared.

One of the earliest patents for scratchcards is U.S. Pat. No. 4,643,454 which issued in 1987.

In U.S. Pat. No. 7,100,822 PIPER & SMITH taught how to run a cardless lottery in which the interaction of all of the players' entries determined the outcome. It had the problem that the end time was indeterminate unless the promoter interfered to terminate the lottery by injecting random entries.

Our earlier WO 2014/027284 teaches a lottery in which 6 symbols are picked from 20 available symbols, and a means to achieve a single winner in the lottery through a ranking process. As the odds of picking 6 symbols from 20 available symbols in order are 1 in 27,907,200, this means that the chances of achieving a single winner of the lottery, each time it is run, are very high.

Our WO2016/042489 describes earlier versions of our lotteries based on links between adjacent cells in a matrix as the symbols on the matrix are drawn at random.

Our WO2016/042490 describes the mapping technology for displaying matrices and displaying and scoring the number of links as a result of a random draw.

Other patents in this area include:

U.S. Pat. No. 8,764,543 “Method and System for Playing a Networked Bingo Game”

U.S. Pat. No. 8,956,212 “Method of Playing a Bingo-Type Game with a Mechanical Technological Aid, and an Apparatus and Program Product for Playing the Game”

U.S. Pat. No. 7,726,652 “Lottery Game Played on a Geometric Figure Using Indicia with Variable Point Values”

US 2004/0119232 “Bingo Type Numbers Game”

And

GB2395915

US2003144550

US2005059468

US2006249897

US2007135205

US2012122539

US2013252697

US2014011565

U.S. Pat. No. 5,560,610

U.S. Pat. No. 8,602,684

U.S. Pat. No. 8,616,952

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that the document, act or item of knowledge or any combination thereof was at the priority date, publicly available, known to the public, part of common general knowledge; or known to be relevant to an attempt to solve any problem with which this specification is concerned.

### DEFINITIONS

Adjoining or adjacent cells: where two cells have a common boundary or point or edge or corner or vertex, so that a line can be drawn from a first cell to a second cell without crossing any other cell.

Base Game Structure: means the underlying game architecture of each relevant game where such: involves one pool of numbers; a base game play method, and one random draw of some or all the pool numbers to result the relevant game.

Base Game Outputs: means the underlying base game outcomes (with each different outcome known as a Base Output Level) (including the odds outcomes) of a Base Game Structure that are randomly produced and where such underlying base game outputs and or outcomes are not altered or changed as a consequence of any add on feature, for example, such as a change when adding a multiplier feature, which can be added to any Base Game Structure so as to increase and or alter such game's base odds and the number of possible outcomes (for example, such as involving the addition of a 1/10 multiplier feature using an additional number pool and draw).

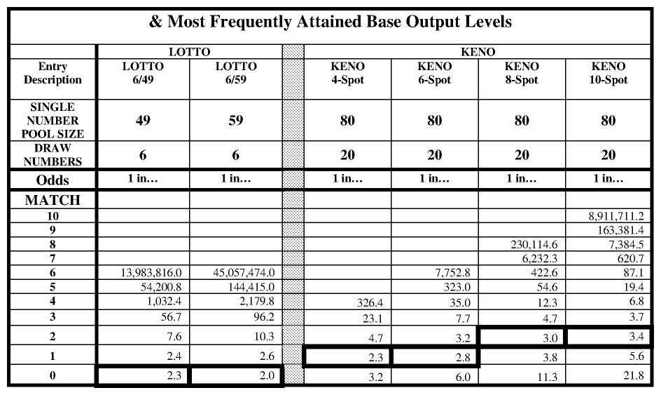

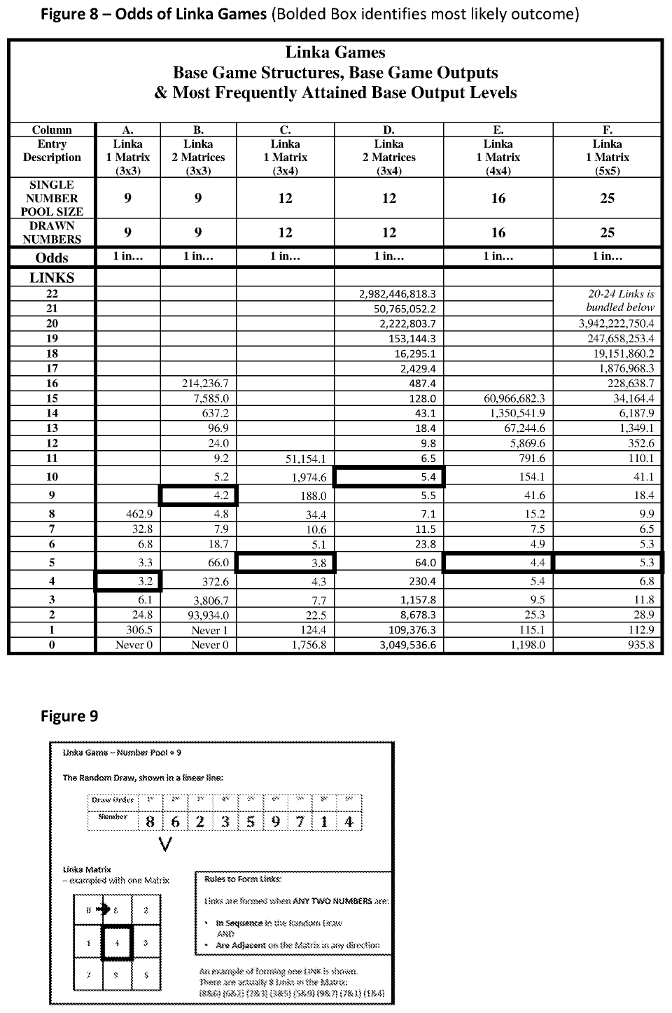

For the avoidance of doubt: the Base Game Outputs of the various identified Base Game Structures and the Most Frequently Attained Base Output Level (which is identified by a single bolded black lined boxing effect around each relevant level) for each Base Game Structure in respect of exampled: base Lotto and Keno games are set out in FIGS. 1A, 1B, 4A and 4B; and base Linka games are set out in FIG. 8.

Card: refers to an entry in a lottery containing at least two or more pre-populated Playing Areas and a card ID. This entry is typically printed on card or paper (hence the name) but can also include a “virtual card” displayed on a screen of a gaming machine, computer or mobile device. As will become apparent the most preferred card layouts have two or more matrices (each matrix comprising one Playing Area) on each card.

Cells: defined areas smaller than the playing area; each cell separated from another cell by a visible boundary, and each cell capable of containing/displaying a symbol. Each cell has a number of adjoining cells within a playing area.

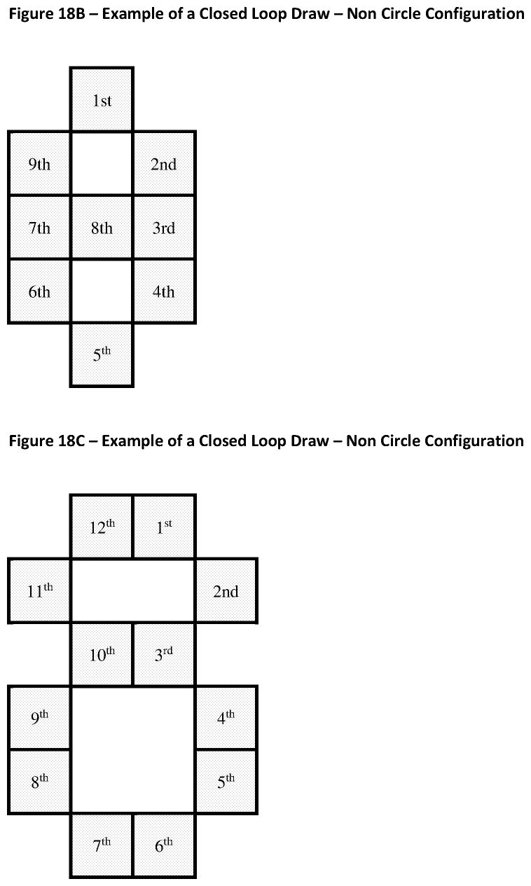

Closed Loop Draw: means any random draw used to result any relevant game where the order of the draw, instead of being displayed in a linear form (as usually occurs in lotto draws), is displayed in a closed loop form where any two numbers that would not otherwise be in direct sequence or contact with each other (or have a recognizable direct association) in any linear display of a relevant draw order (for example as would be the case with the first and last drawn numbers) would, as a result of being displayed in a closed loop form, be in direct sequence or contact (or have a recognizable direct association) with each other. For the avoidance of doubt: Three examples of a closed loop draw are set out in: FIG. 18A which shows a circle configuration resulting in a direct sequence and association of the last drawn number with the first drawn number; and FIGS. 18B & 18C which example two non-circle closed loop configurations.

Comprise: It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Incremental Success(es): means, in respect of each relevant Base Game Structure, the measurable attainment based on random probability of each Base Output Level towards and including (but not exceeding) the Most Frequently Attained Base Output Level.

Link-lottery: a type of lottery in which links are created between adjoining cells within each of one or more playing areas on a card entered in the lottery, if when symbols are drawn and displayed in a linear or loop sequence, two neighbouring symbols in that sequence also are present in adjoining cells in at least one of the playing areas on the card. This type of lottery is described in WO2012/042489 and WO2012/042490. It is sometimes referred to herein as a “Linka game” or “Linka lottery” or as a suffix in games labelled “KenoLinka” OR “LottoLinka”.

Link: a situation where two adjoining cells contain symbols which are neighbours in the list of symbols drawn in the lottery; links can be designated graphically by a line or an arrow crossing the boundary between adjacent cells.

Matrix: refers to a generally rectangular array of cells capable of containing unique symbols, typically numbers or letters, arranged in rows and columns. For example, the most preferred matrix used in this invention is a 3×3 matrix of cells as there are three rows and three columns of cells.

Matrices: means two or more Matrix.

Most Frequently Attained Base Output Level: means the most frequently attained base output level as determined by reference to the mathematical chances/odds for each base output level from amongst all the Base Game Outputs produced by a relevant Base Game Structure.

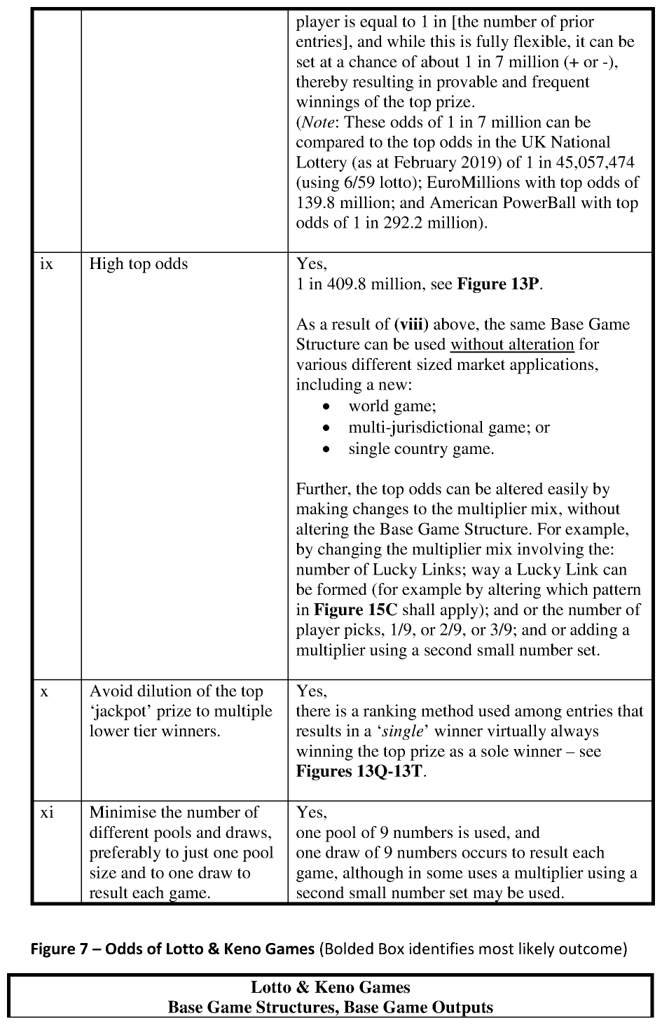

For the avoidance of doubt: the Most Frequently Attained Base Output Level of various Base Game Structures in respect of the 6/49 Lotto game and the Keno games are set out in FIG. 7 (in the base 6/49 lotto draw game, it is 0 matches; (b) in the base 4-Spot and 6-Spot Keno draw games, it is 1 match; in the base 8-Spot and 10-Spot Keno draw games, it is 2 matches); and Linka games are set out in FIG. 8 (in the base Linka game using 2 matrices of a 3×3 configuration, it is 9 links), with each relevant Most Frequently Attained Base Output Level being identified in FIGS. 7 and 8 by a single bolded black lined boxing effect around each relevant level, or alternatively as can be determined by reference to the mathematical chances/odds for each base output level.

Playing Area: means a two dimension collection of neighbouring cells in which the majority of cells have 3 or more neighbours, as explained in the Statement of Invention. A preferred type of playing area is a matrix having rectangular arrangement of cells in rows and columns as this is easier for a participant to check for links between neighbouring cells.

### OBJECT OF THE INVENTION

It is an object of the invention to provide a set of cards for a link-lottery using a small number pool or a small pool of symbols that ameliorates some of the disadvantages and limitations of the known art or at least to provide the public with a useful choice.

### STATEMENT OF INVENTION

In a first aspect the invention provides a set of cards for a link-lottery wherein each card contains at least two playing areas, each playing area comprising a plurality of adjoining cells, wherein each cell contains a symbol selected from a set of symbols, the symbol in each cell being different from the symbol in the other cells on that playing area, wherein the size of the set of symbols is between 6 and 16 symbols, means for displaying or recording links between adjoining cells in each playing area if the adjoining cells contain symbols which have been drawn or displayed in sequence in the link-lottery.

Preferably, the symbols may be numerals, as commonly used in lotteries such as Lotto or Keno. These may be Arabic numerals, as these symbols are easily recognised and easily distinguished from one another. They may also be sequential or non-sequential.

However, it will be appreciated that a wide range of other symbols fall within the scope of the present invention, so long as the symbols in a given set are readily distinguishable one from the other. In some embodiments we have created cards using well-known cartoon characters, and in others we have used letters a selection of letters from the alphabet but examples of other sets of symbols include and are not limited to for example the images of playing cards, or pictures of dominoes.

Preferably, each playing area comprises a generally two-dimensional array of cells. Reference to “a generally two-dimensional array” includes both two-dimensional configurations per se, and configurations wherein the array of cells has a three-dimensional element (such as a degree of depth or height between adjoining cells or between different regions of the array of cells), for example for decorative purposes. All such embodiments are to be considered a “generally two-dimensional array of cells” so long as, when the playing card is viewed substantially from the front, the player will be able to determine the links between cells containing symbols when the link-lottery is drawn.

Preferably, at least the majority of the cells in each playing area adjoin at least three other cells in that playing area giving rise to the possibility of at least three chances to form a link between each of said majority of cells and its adjoining cells when the link-lottery is drawn.

More preferably, all of the cells in each playing area adjoin at least three other cells in that playing area.

Preferably the at least two playing areas are of different sizes, wherein the larger playing area comprises more cells than the smaller playing area.

Preferably the at least two playing areas are of different shapes. Preferably at least one of the playing areas on each card is a matrix of m×n cells. Preferably at least one of m or n is 3 or 4.

Preferably m and n have equal values.

More preferably, each card has two 3×3 matrices. The combination of these two matrices and the number of possible adjoining cells in each matrix results in a player always having at least two links when the nine available symbols have been drawn. For example in a single 3×3 matrix the corner cells each have 3 adjoining cells (e.g. side, side, corner) so 3 possibilities for links, the outer middle cells have 5 possibilities for links as each has 3 sides and 2 inwardly facing corners, and the central cell has 8 possibilities for links as it has 4 sides and 4 corners surrounded by other cells.

The odds table, charts and Figures discussed later in this specification show the preferred card configuration of two 3×3 matrices has a most probable outcome of six links per card, meaning the player has experienced successes by achieving 1, then 2, then 3, then 4, then 5 and then 6 links and making the player feel that they have come very close to winning, if for example prizes are allocated from eight or more links. With two 3×3 matrices on the card, making use of the same nine symbols on each matrix, albeit in different layouts on each matrix, with a linear draw there is a maximum of eight possible links per matrix, and hence a maximum of 16 links across the two matrices. In other words the number of potential links on a card is additive across the number of matrices on the card, but the number of permutations of possible card layouts is multiplicative based on the number of permutations of the layout of the cells in each matrix. This type of matrix game is attractive as the player will quickly see a number of links being built up on their card as the symbols are drawn by the lottery operator.

Preferably each card has designated locations on the card for recording the number of links per playing area.

In some cases, each card has an area for recording the combined total number of links.

In other cases, each card has an area for recording the number of matrices with the same number of links.

The inventive step according to this aspect of the invention is the provision of a limited number of card layouts which can be used with a small pool of symbols, this pool of symbols being between 6 and 16 symbols, with symbols arranged in at least two playing areas on each card layout. Each playing area is a generally two-dimensional arrays of cells, such that the majority of cells in each playing area adjoin at least three other cells in that playing area giving rise to the possibility of at least three chances to form a link between a cell and its adjoining cells. This configuration gives rise to a large number of “near win experiences”. By counting the total number of links achieved on a card (or the number of matrices with the same number of links) after a draw of the symbols one after the other, the total number of links can be additive but the number of card permutations is multiplicative.

In another aspect the invention provides a set of cards for a link-lottery wherein each card contains at least two playing areas, each playing area comprising adjoining cells in a primarily two dimensional configuration, wherein at least a majority of cells of each playing area have at least 3 adjoining cells, wherein each cell on each playing area contains a symbol from a set of symbols, wherein the symbol on each cell of each playing area is different from the symbols on the other cells on that playing area, wherein the size of the set of symbols is between 6 and 16 symbols, wherein each card has an area for recording the sequence of the symbols drawn during the lottery.

As shown in the odds table for cards with two or more matrices, the large number of possible card layouts with two or more matrices means that the same layout of the matrices on the cards is unlikely to be duplicated for a winning combination, so that an ordered or random allocation of symbols to each matrix can be used when generating a set of cards.

In some cases it is preferred that the set of cards is generated in such a way that each card differs from each other card, although it is likely that one of the matrices on a card may appear on one or more other cards—but it is not likely that both matrices will appear on one or more other cards. This may involve the ordered creation of all possible matrix layouts (in the case of 3×3 matrix this is 9 permutation, expressed as 9!), and the ordered creation all permutations of all matrix layouts (9!×9!) or a subset of all possible such combinations.

Preferably each card has an area for recording the number of links in each playing area resulting from a sequential draw of the set of symbols.

Preferably each playing area on a card is a matrix of m×n cells.

Preferably at least one of m or n is 3 or 4.

Preferably m and n have equal values.

In another aspect the invention provides a set of cards for a link-lottery wherein each card contains at least two matrices, each of the matrices being a matrix of m×n cells, each cell containing a symbol from a set of symbols, the symbol in each cell of each of the at least two matrices being different from the symbols in the other cells of that matrix, wherein the size of the set of symbols is between 6 and 16 symbols, each card further comprising means for displaying or recording links between adjoining cells if adjoining cells contain symbols which have been drawn in sequence.

Preferably at least one of the matrices on each card has at least 3 rows or 3 columns of symbols.

Preferably, for each card in the set of cards the matrices are populated with the symbols in a pattern unique to that card and different from the other cards in the set.

In practice each card will be unique within a set as it will have a machine readable code unique to that card.

In a further aspect the invention provides a set of cards for a link-lottery, each card having at least two matrices, each of the matrices having a defined layout comprising at least a subset of a set of symbols, wherein the set of symbols comprises between 6 and 16 different symbols, wherein each symbol in the set of symbols appears no more than once on each matrix, so that each card has a different layout of symbols from each other card, and wherein at least one of the matrices on each card is selected from the group comprising matrices of the following sizes: 2×3, 3×3, 3×4, and 4×4.

Preferably each card has at least one additional matrix of 2×2 configuration.

Preferably each card also includes instructions for playing the game based on a draw of the symbols and the creation of links, and prize rules setting out the number of links needed to claim a prize.

Preferably each card is a scratch card and the symbols on the matrices are hidden under a removable layer, so that the symbols can only be revealed by removing the removable layer.

Preferably each card is a scratch card and the draw of the symbols is hidden under a removable layer, so that the draw of the symbols can only be revealed by removing the removable layer.

Preferably each card also includes at least one machine readable code.

In a further aspect the invention provides apparatus for conducting a link-lottery, including a server, a communication network with a plurality of retail outlets, at least one printer at each outlet, and set of virtual cards for the link-lottery, wherein each virtual card is stored in the server with instructions to allow individual physical cards to be printed on demand on a paper or card or other substrate at one of the retail outlets in return for an entry in a lottery, each virtual card having stored information to allow the printing on the physical card of at least two playing areas, each playing area made up of adjoining cells in a generally two dimensional configuration so that the majority of cells on each playing area have at least 3 adjoining cells, each cell containing a different symbol from the other cells on that playing area wherein the size of the set of symbols is between 6 and 16 symbols and wherein each virtual card differs from each other virtual card in the set, each virtual card containing an area for recording the sequence of the symbols drawn during the lottery and preferably containing instructions in relation to printing and recording the sequence of the symbols drawn on the physical card.

In another aspect the invention provides apparatus for conducting a link-lottery, including a server, a communication network, and a plurality of visual display units (VDUs) each capable of communicating with the server, and set of virtual cards for the link-lottery, wherein each virtual card is stored in the server with instructions to allow individual cards to be presented on demand to one of the visual display units (VDUs) on receipt of an entry in a lottery, each virtual card having stored information to allow the display on one of the virtual cards on the VDU of at least two playing areas, each playing area comprising adjoining cells in a generally two dimensional configuration so that the majority of cells have at least 3 adjoining cells, each cell containing a different symbol from the other cells on that playing area, and wherein the size of the set of symbols is between 6 and 16 symbols and wherein each virtual card differs from each other virtual card, or based on random possibilities each virtual card is very likely to differ from each other virtual card, and instructions to display on the VDU of an area for recording the sequence of the symbols drawn during the lottery.

Preferably each visual display unit is adapted to display the ranking of each cell in a matrix as each cell number is selected during the course of a game.

Preferably each visual display unit is adapted to display links between sequentially selected symbols in adjacent cells.

Preferably the plurality of visual display units are adapted to receive and send game information from and to the game server which is adapted to (a) record entries, (b) use a random or pseudo random selection process for the symbols during the course of a game and (c) to relay information on the selection of the symbols to each visual display unit.

Preferably the plurality of visual display units are or form part of casino machines which are connected to a game server by a secure network.

Preferably the plurality of visual display units are or form part of machines chosen from the group comprising: personal computers, gaming machines, tablets, smart phones, hand held or portable machines, and the like.

In another aspect the invention provides a set of cards for use in a link-lottery in which symbols are drawn in sequence from a set of s different symbols, each card having an area for recording the sequence of the symbols drawn during the lottery and at least two matrices each having a layout of adjoining cells in a substantially rectangular array having rows and columns wherein each cell contains a symbol from the set of s symbols wherein s is from 6 to 16, and at least one of the matrices having a minimum of three rows or three columns, and the layout of the symbols on each card differing from the layout of the symbols on each other card or based on random possibilities being very likely to differ from the layout of symbols of each other virtual card.

Preferably the layout of the symbols on each matrix on a card differs from the layout of the symbols on the other matrices on that card.

Preferably each card has two or more matrices of identical size.

Preferably each card has two matrices of 3×3 configuration

Preferably each card has three 3×3 matrices

Preferably each card has a set of four 3×3 matrices.

Preferably each card has two or more matrices of different size.

Preferably each card is a scratch card, such that removal of at least part of the scratchable layer to produce a “reveal state”, reveals the result of a draw.

Preferably the reveal state also shows the resulting links from that draw having being displayed on the matrices.

Preferably each card also includes a machine-readable code.

Preferably the symbols are numbers.

In a further aspect the invention provides a link-lottery comprising a plurality of tickets/cards each having the same set of symbols as all other tickets in that lottery, each set of symbols being arranged on each of a pair of identical m×n matrices each having a total of m×n cell locations, where m can be 2,3, or 4 (the number of rows or columns in each matrix) and n can be 3 or 4 (conversely the number of columns or rows in the matrix) with each matrix being made up of the same set of symbols but the layout of the symbols (i.e. cell location of each symbol) differing from matrix to matrix, the set of symbols being made up of from 6 to 16 symbols (the product of m×n), wherein the symbols can be ranked (drawn in a random sequence) and links displayed when/where two or more adjacent symbols are sequentially related.

Preferably the symbols are a set of numbers.

The symbols or numbers need not be sequential, and it is possible to have a mixed collection of symbols, e.g. A, 7, Z, +, 22, Q, 9.

Preferably the set of numbers comprises 9 sequential numbers arranged in different layouts on a pair of 3×3 matrices on each ticket or card. (Such a set is easy to check as these are the most commonly used numbers and hence easy to distinguish one from the other).

In a further aspect the invention provides a set of cards for a link-lottery in which numbers are drawn at random, each card having at least two matrices capable of containing at least a portion of a set of s numbers with s being from 6 to 16, at least one of the matrices having a minimum of three rows or three columns (giving a 2×3 matrix as the minimum matrix size, matching the lower limit of six numbers) and a 4×4 matrix as the maximum matrix size, to match the 16 numbers, allowing for two or more matrices selected form the group comprising 2×3, 3×3, 3×4, and 4×4 matrices, wherein, once each of the matrices on each card is populated with the set of s numbers, the layout of the numbered matrices on each card is different to that of every other card in the set.

Preferably the layout of the numbers on each matrix on each card differs from the layout of the numbers on the other matrices on that card.

Preferably each card has two or more matrices of identical size.

Most preferably each card has at least two matrices of 3×3 configuration.

Preferably each card has three 3×3 matrices.

Preferably each card has a set of four 3×3 matrices.

Preferably each card has two or more matrices of different size.

Preferably each card is a scratch card, such that removal of the scratchable layer produces a “reveal state” showing the result of a draw

Preferably the reveal state also shows the resulting links from that draw having being displayed on the matrices

Preferably each card also includes a machine-readable code.

### BRIEF DESCRIPTION

These and other aspects of the inventions, which will be considered in all their novel aspects, will become apparent from the following descriptions, which are given by the way of examples only, with reference to the accompanying drawings in which:

FIG. 1A a shows a table of odds and outcomes for 6/49 lotto (prior art)

FIG. 1B shows a table of odds and outcomes for 6/59 lotto (prior art)

FIG. 2 shows the top odds resulting from picking different entry numbers (from 3-7) from a range of number pools ranging in size from 7-50 numbers (prior art)

FIG. 3 is a table of the top odds resulting from picking different entry numbers (from 3-6) from a range of number pools ranging in size from: 50, 80, 100, 125, and 150 numbers (prior art)

FIGS. 4A and 4B show the odds and outcomes in traditional Keno games

FIG. 5 shows the changes to the game design of the American Powerball lotto game from 1992 to February 2019 (prior art)

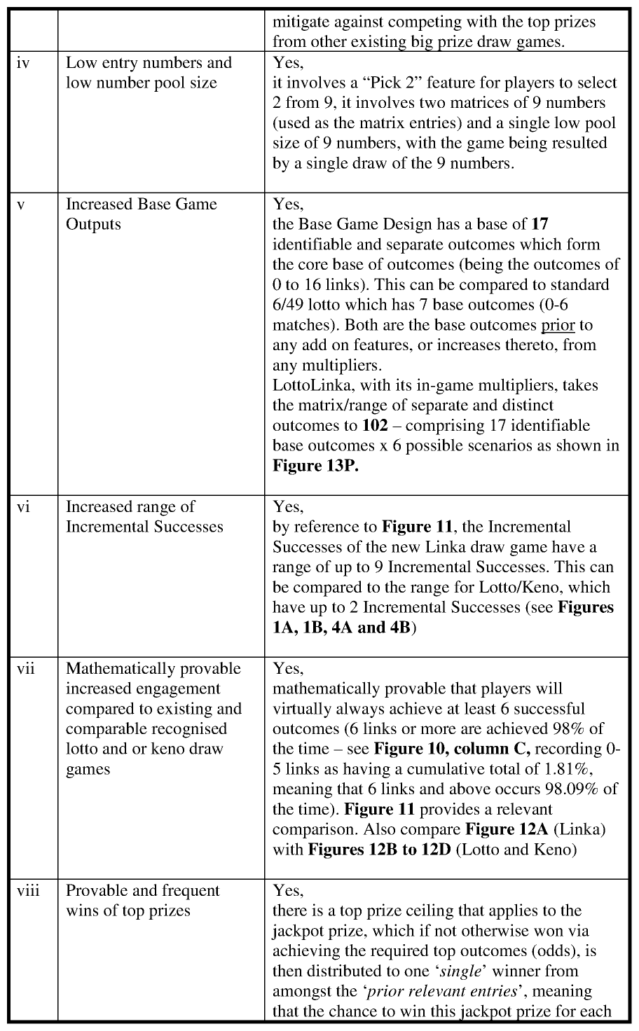

FIG. 6 is a table showing the issues addressed in the development of the preferred game design of this invention

FIG. 7 is a table of odds and outputs comparing different prior art Lotto and Keno games

FIG. 8 is a table of odds and outputs of different linka games

FIG. 9 is a schematic of a lottery card having one 3×3 matrix, in order to illustrate how links are formed.

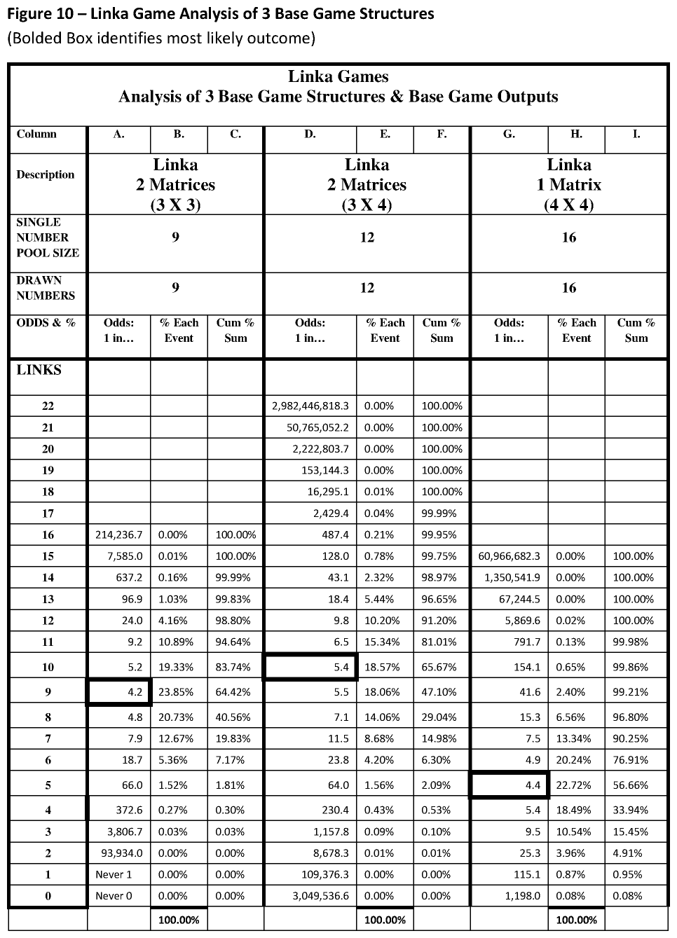

FIG. 10 is a table of odds comparing three different linka games of this invention, namely a card having two of the 3×3 matrices, two of 3×4, and a single 4×4 matrix.

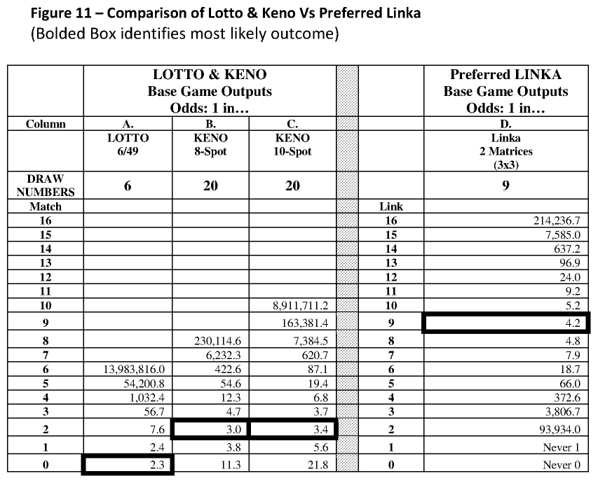

FIG. 11 is a comparison table showing the odds of Lotto and Keno games compared with the preferred game of this invention comprising two matrices of 3×3 on the same Card

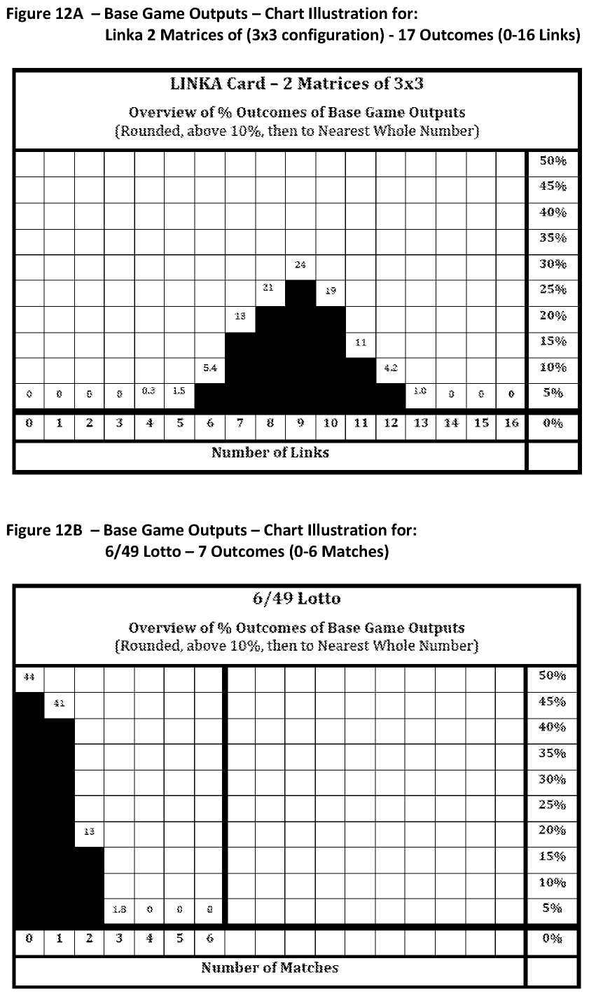

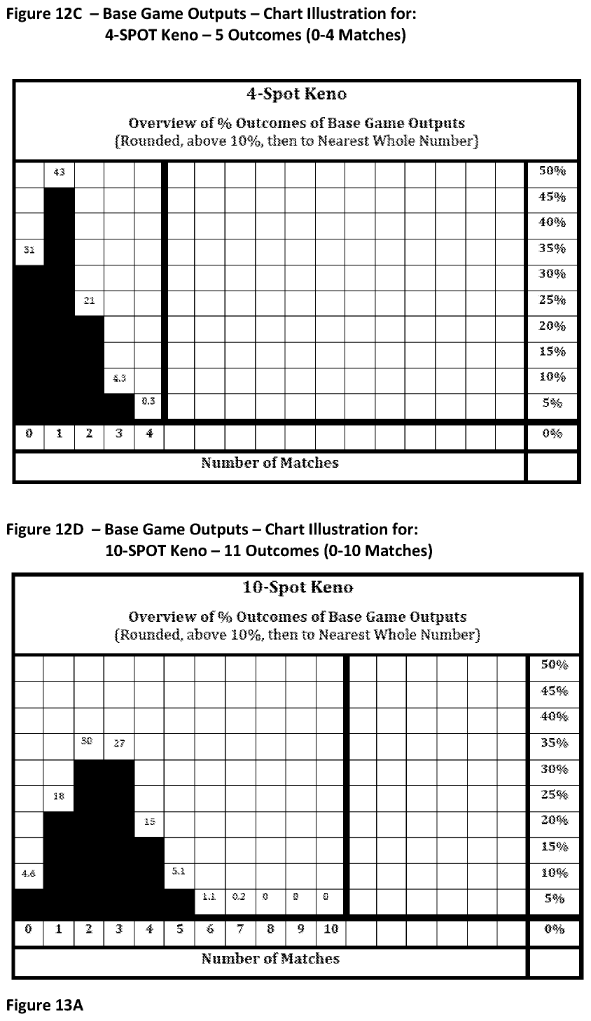

FIG. 12A is a chart showing the number of links achievable (maximum of 16 links) and the percentage outcomes of each output with the preferred game of this invention

FIG. 12B illustrates the number of matches achievable (maximum of 6 matches) and the percentage outcomes of each output for a 6/49 lotto game

FIG. 12C illustrates the number of matches achievable (maximum of 4 matches) and the percentage outcomes of each output for a four spot Keno game

FIG. 12D illustrates the number of matches achievable (maximum of 10 matches) and the percentage outcomes of each output for a 10 spot Keno game

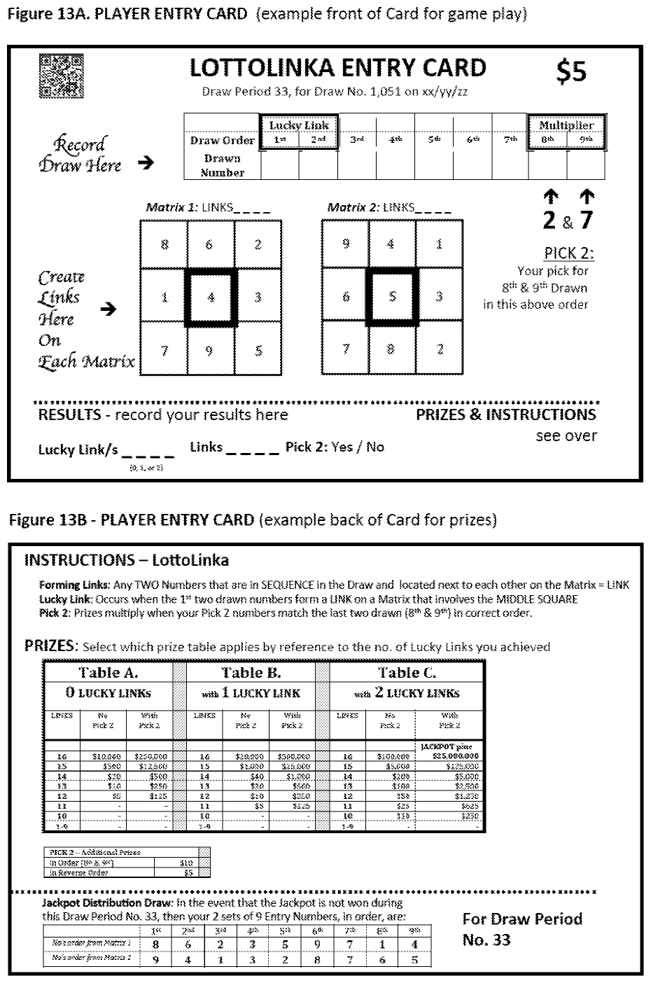

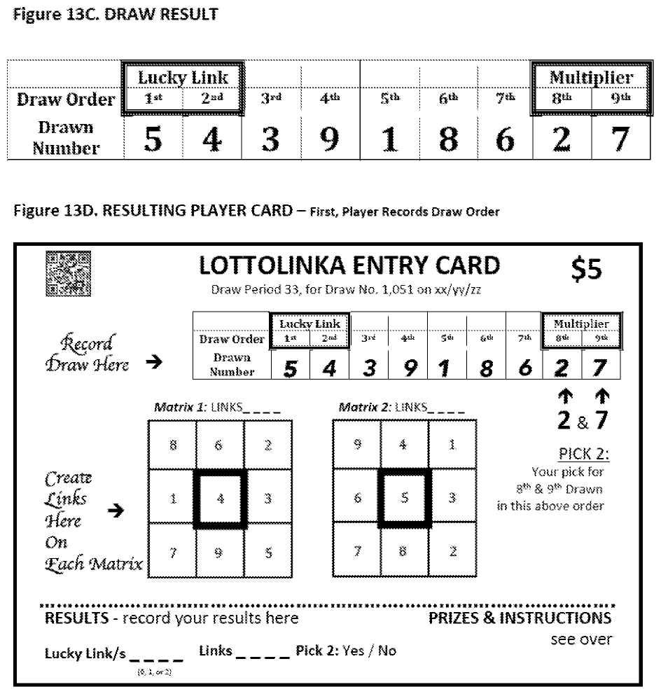

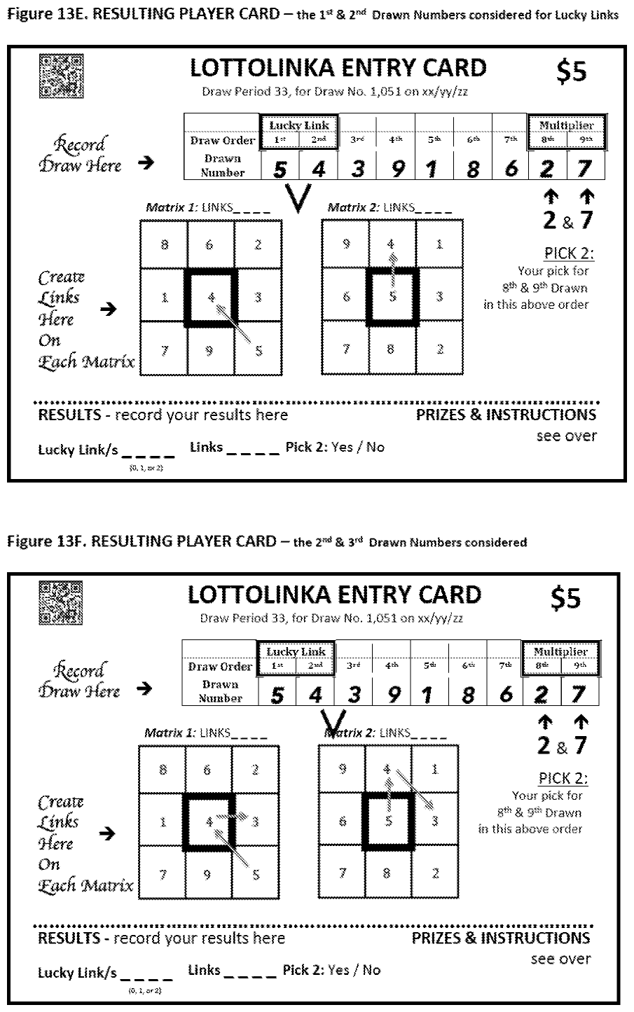

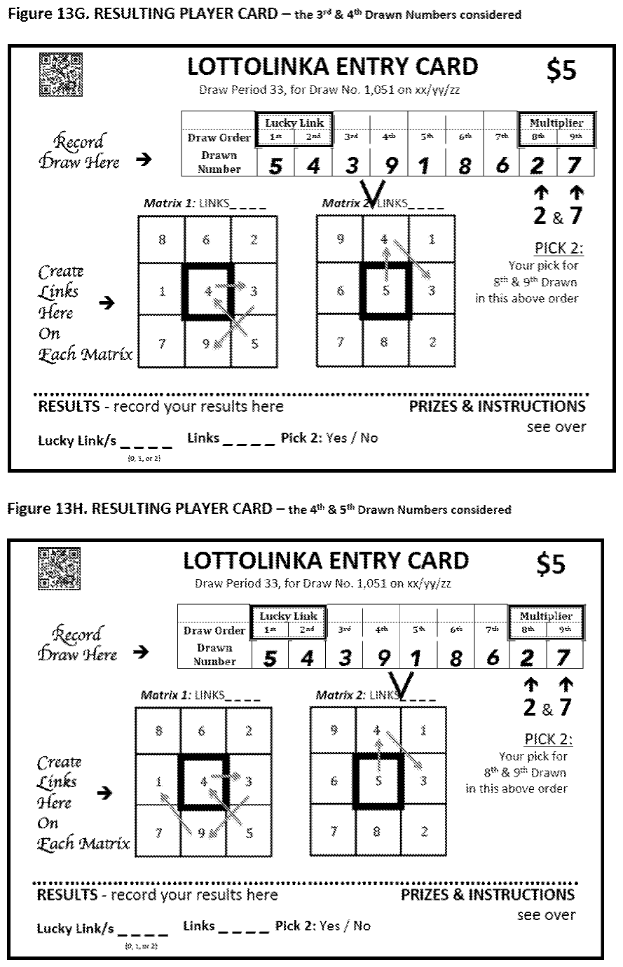

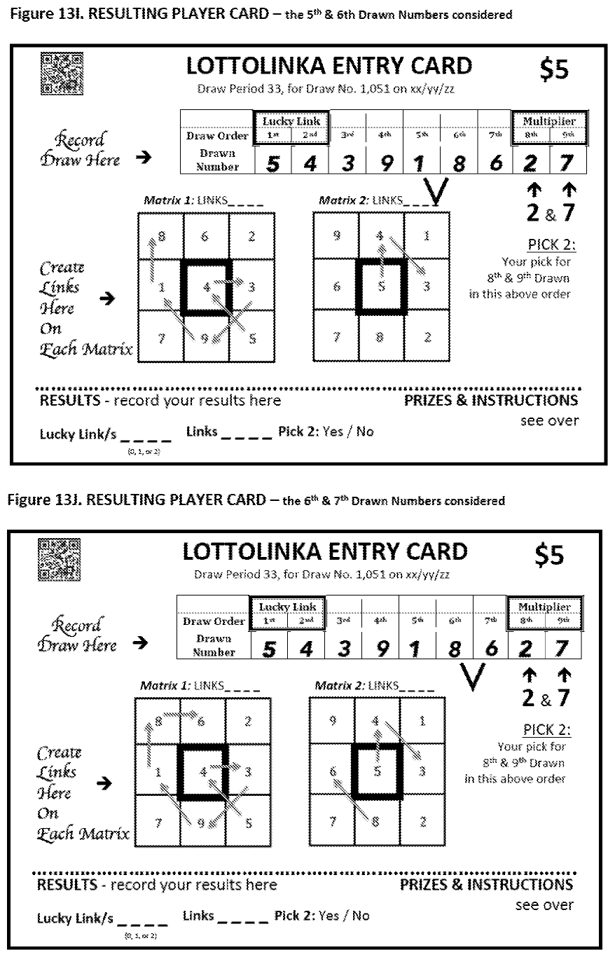

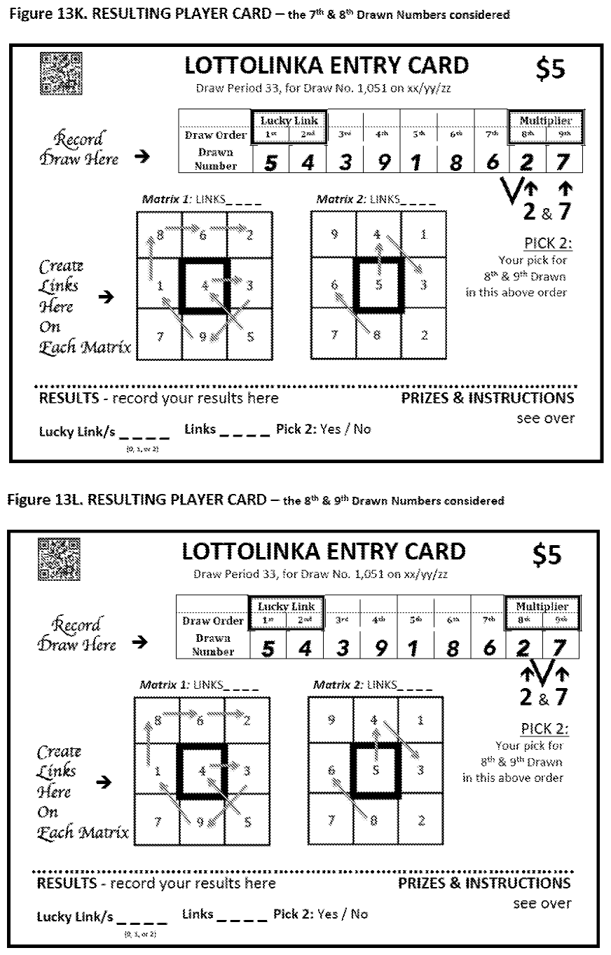

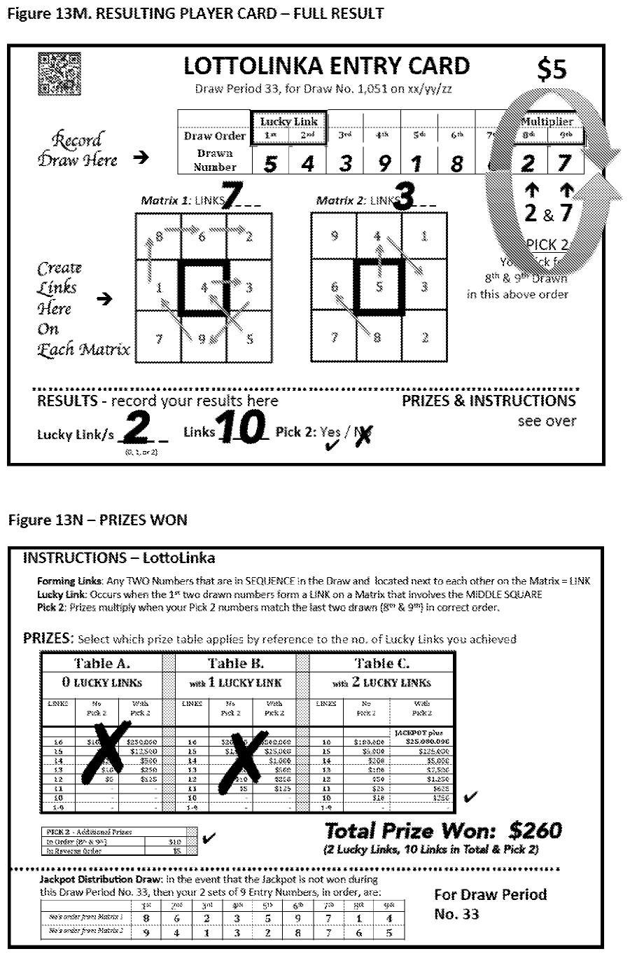

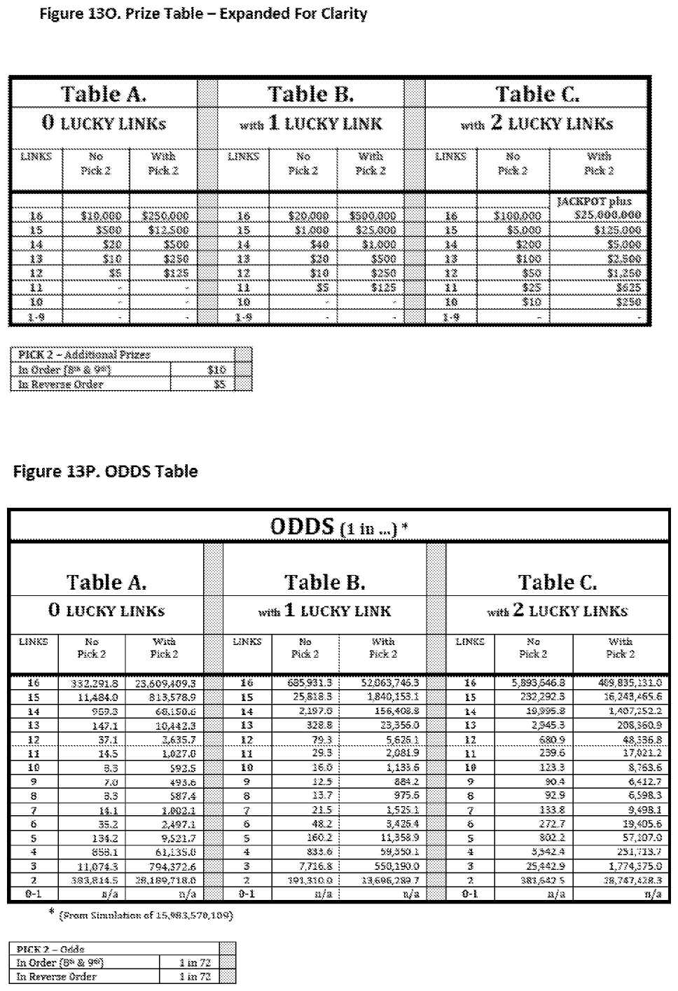

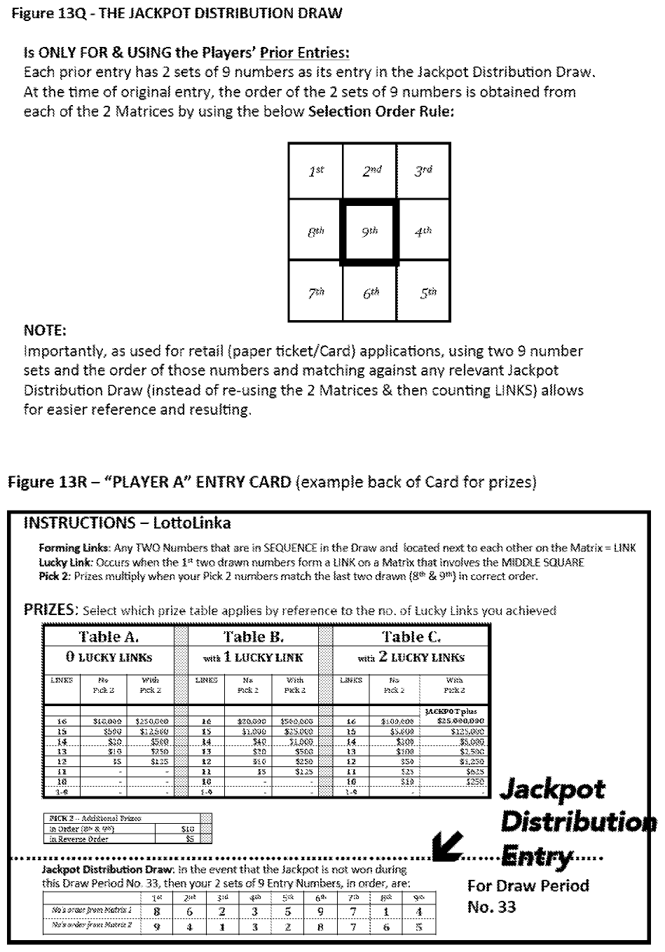

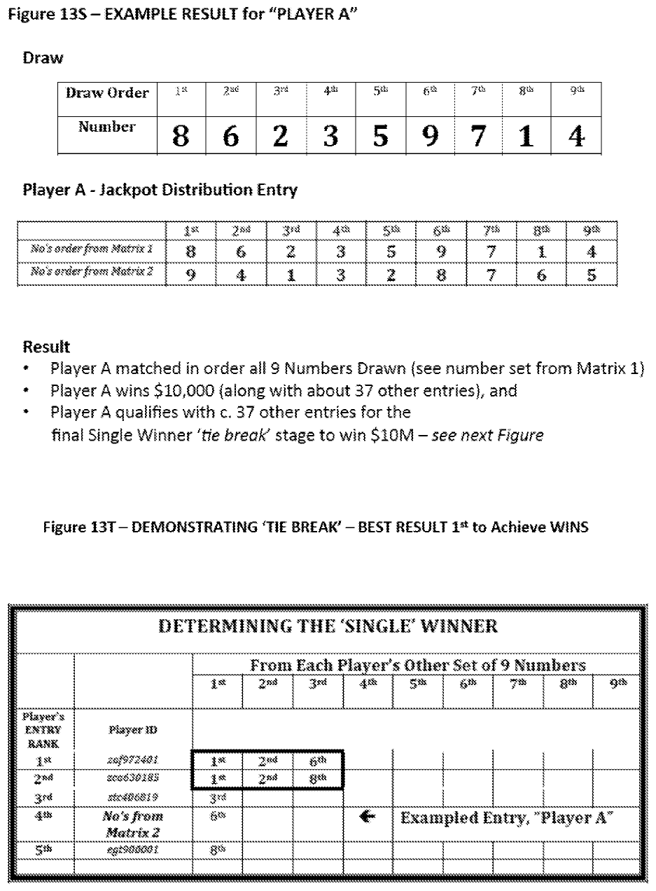

FIG. 13A shows the layout of the front face of a preferred player entry card having two 3×3 matrices on the card.

FIG. 13B shows the instructions included on the reverse face of the card of FIG. 13A.

FIG. 13C shows the result of a random draw applicable to the player entry card of FIG. 13A

FIG. 13D shows the player entry card of FIG. 13A after the random draw has taken place, and a draw results entered on the card

FIGS. 13E-13M shows the sequential consideration of the formation of the different links as the player applies the results of the random draw to the two matrices on the card. FIG. 13M shows the final result with a player having scored both the number of links and the two available lucky links, successfully matched the “Pick 2” prize multiplier.

FIG. 13N shows the prizes won, with the player being eligible (as a consequence of achieving 2 lucky links) for prizes from the prize table C on the reverse of the card.

FIG. 13O shows the prize table of FIG. 13B in expanded form for clarity

FIG. 13P set out the odds of each possible output or event in the preferred game design of this invention, set out in tables A B and C

FIG. 13Q sets out the selection order rule used to order the 2 sets of 9 numbers in relation to an entry in a jackpot distribution draw

FIG. 13R illustrates the jackpot distribution entry on the back of the card of “player A”

FIG. 13S is an example result for “player A” of FIG. 13R

FIG. 13T illustrates how to determine a single winner in the jackpot distribution draw

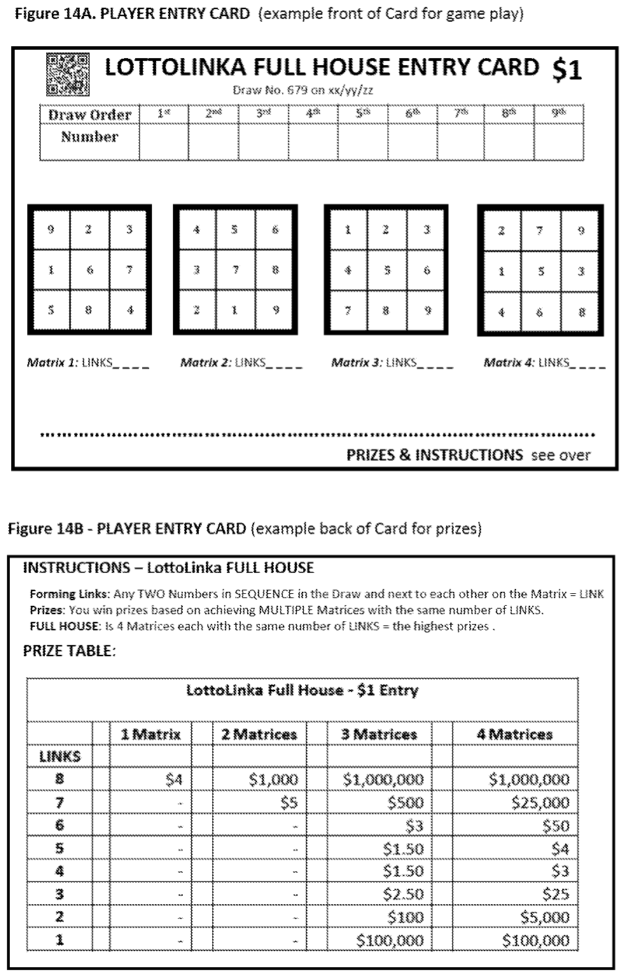

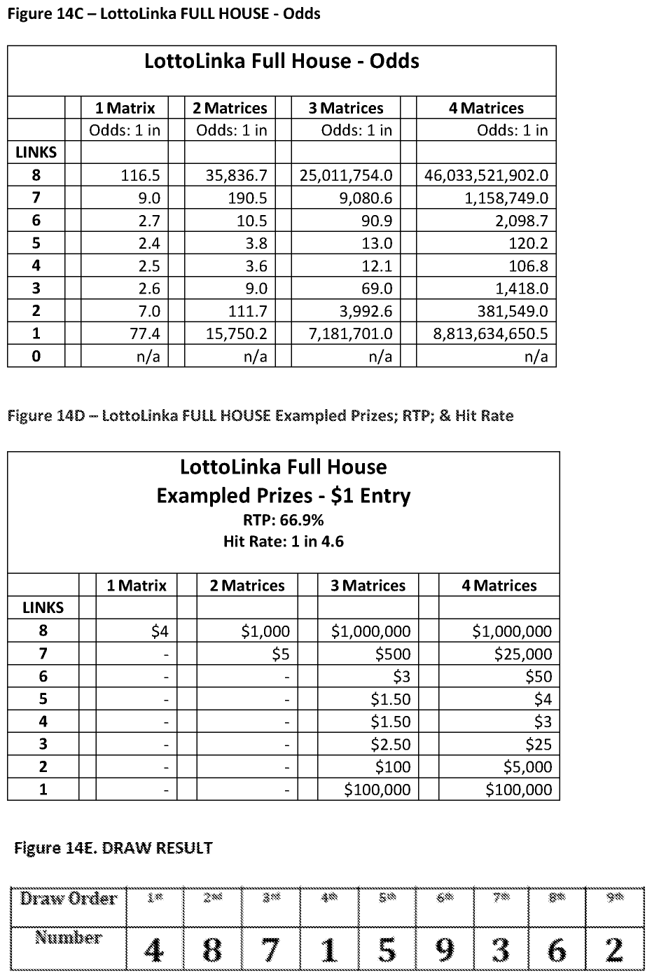

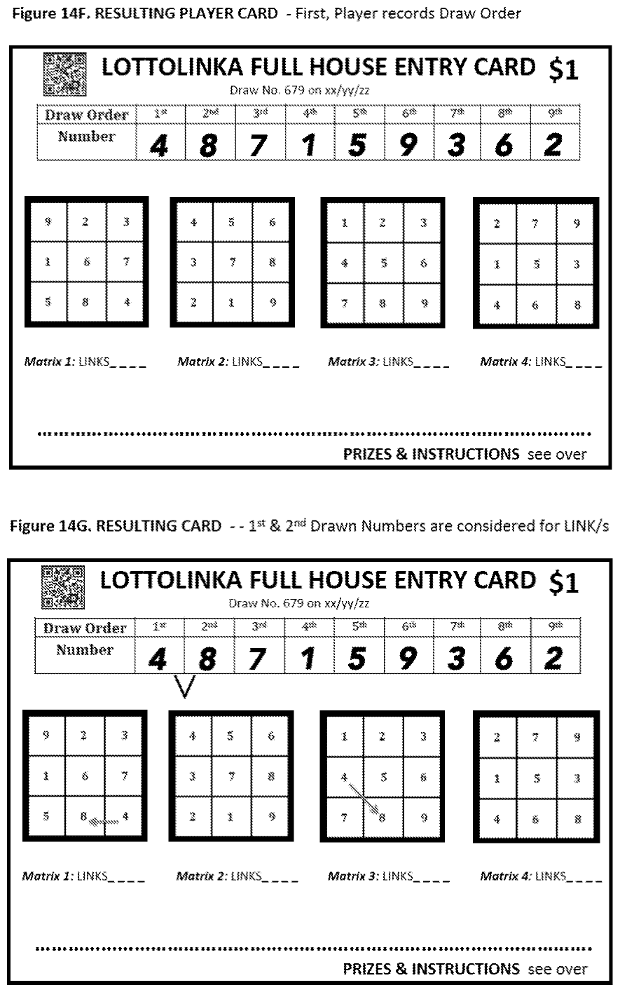

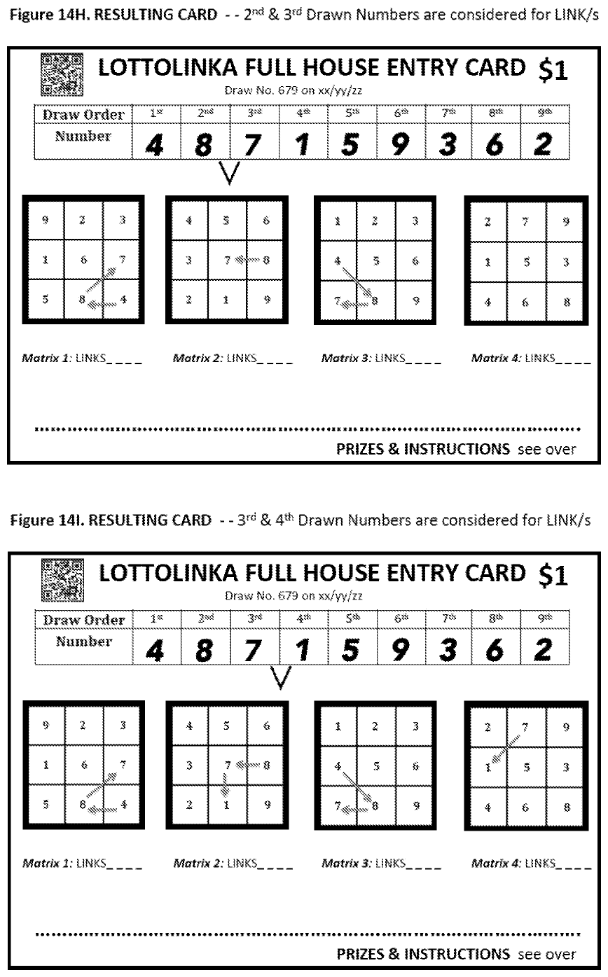

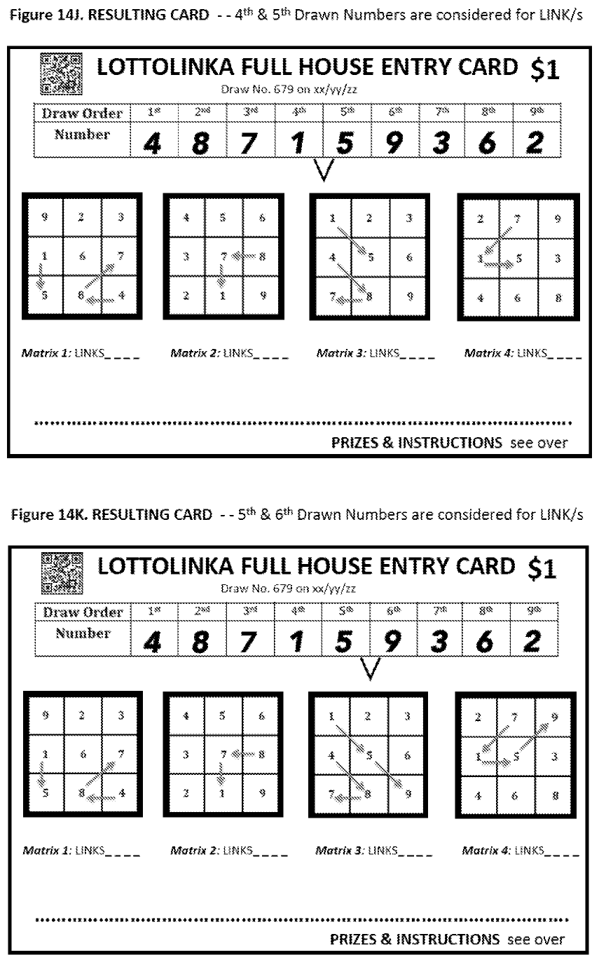

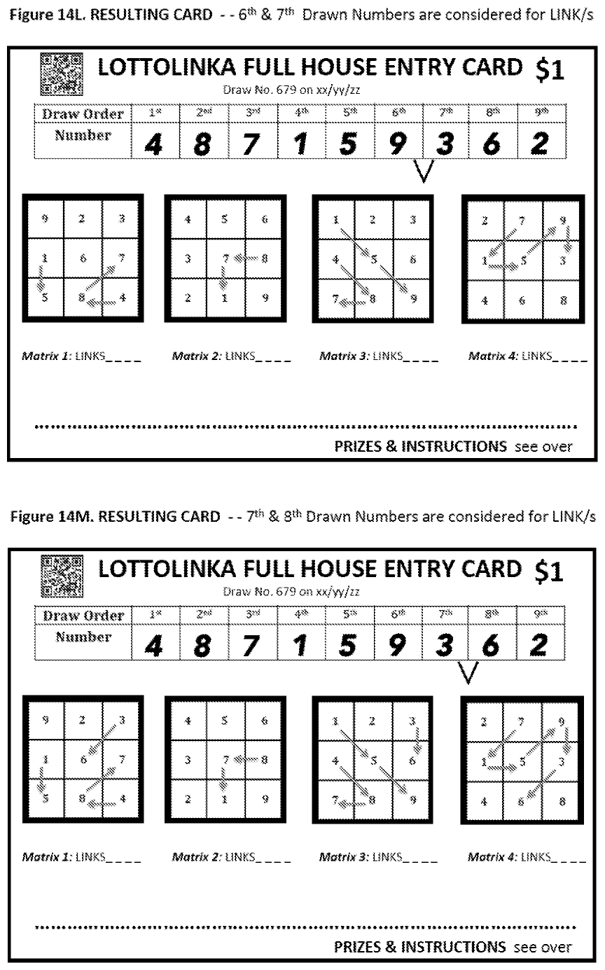

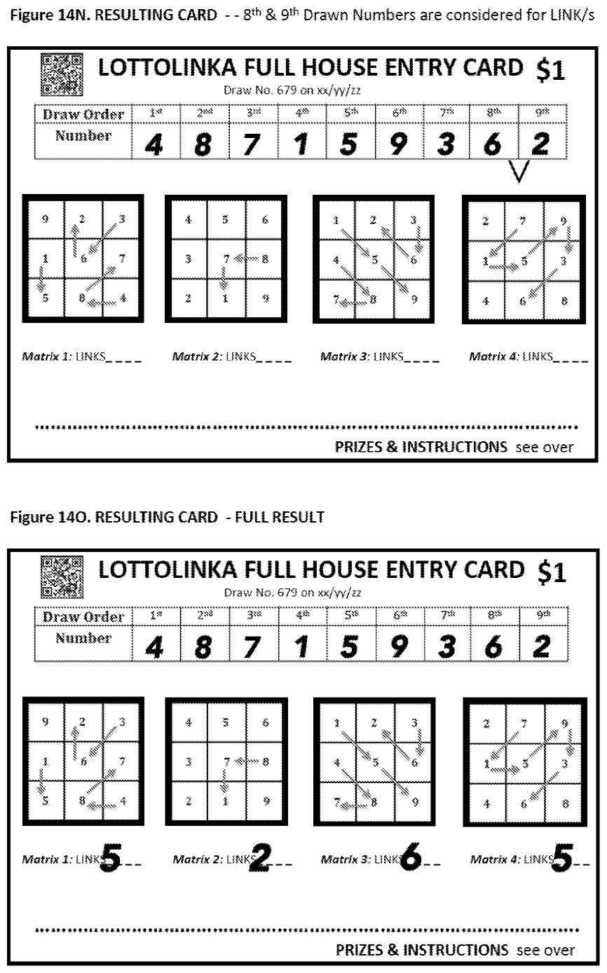

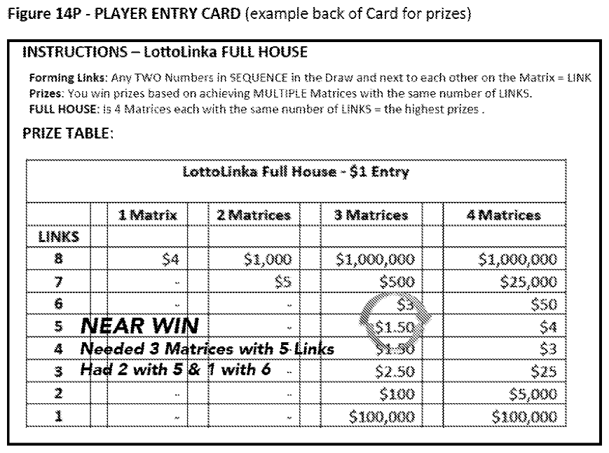

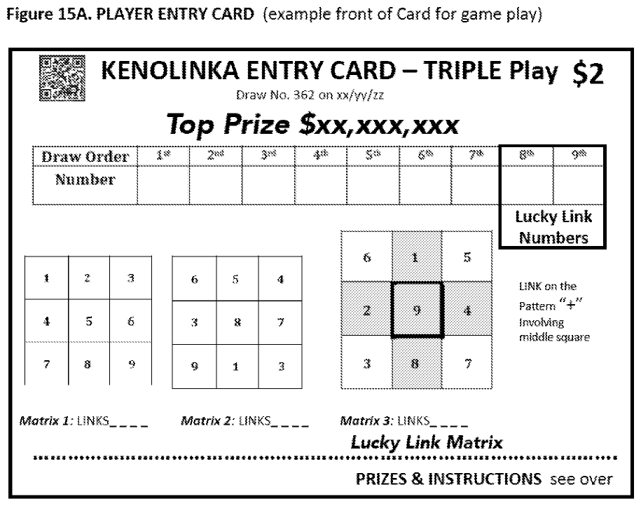

FIG. 14A shows a player entry card having four sets of 3×3 matrices

FIG. 14B shows the reverse of the card of FIG. 14A

FIG. 14C illustrates the odds for the layout of FIG. 14A

FIG. 14D illustrates examples of prize amounts for the card of FIG. 14A

FIG. 14E illustrates a draw result for the card of FIG. 14A

FIG. 14F shows the player card of FIG. 14A with the draw order inserted by the player

FIG. 14G shows the same card with the first two numbers drawn being considered for possible links on the matrices

FIGS. 14H-14N shows the sequential consideration of the other drawn numbers for possible links

FIG. 14O shows the player card of FIG. 14A with the final result of the number of links per each matrix

FIG. 14P shows a reverse of the card of FIG. 14O with result that the player did not win a prize but had a near win experience

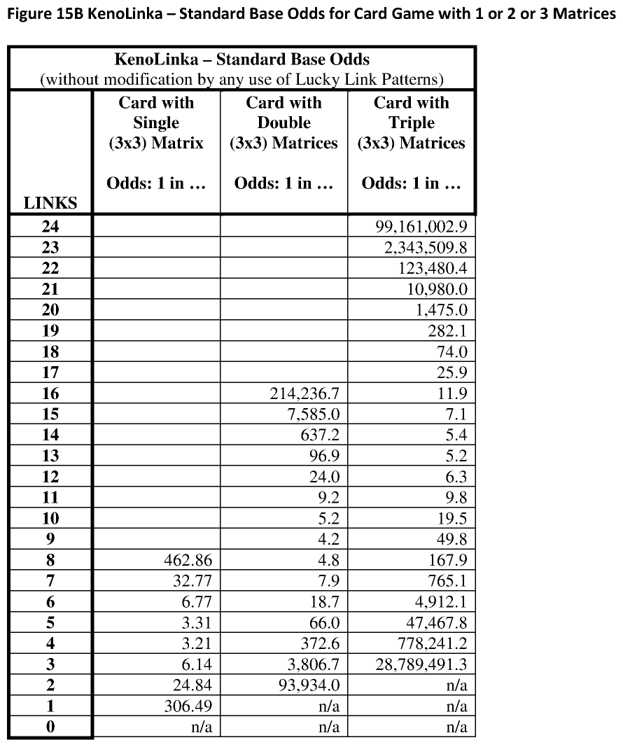

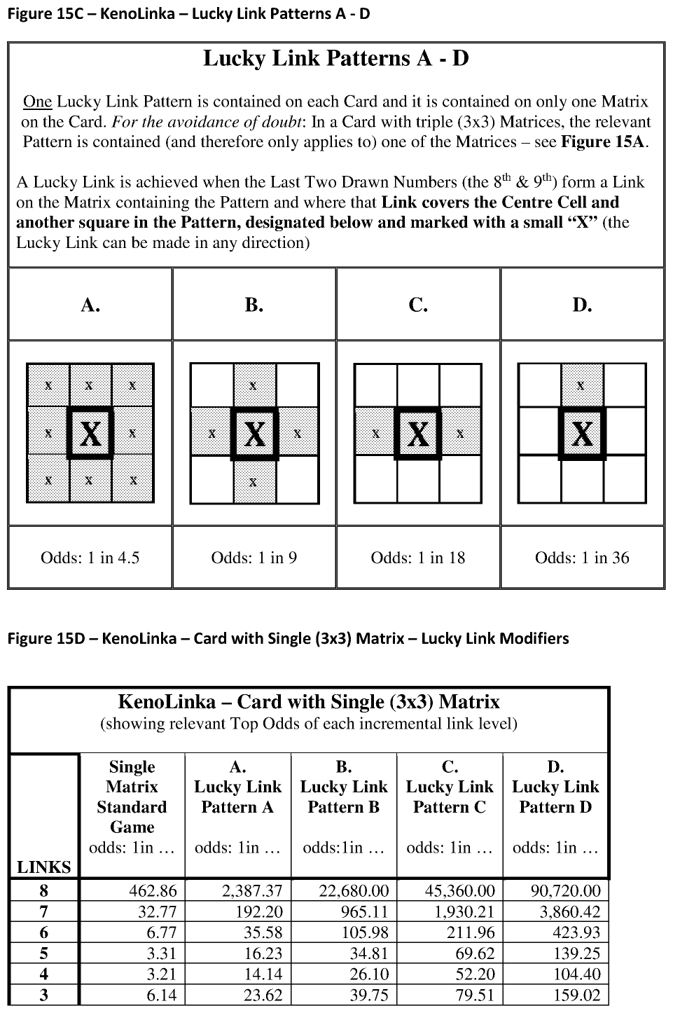

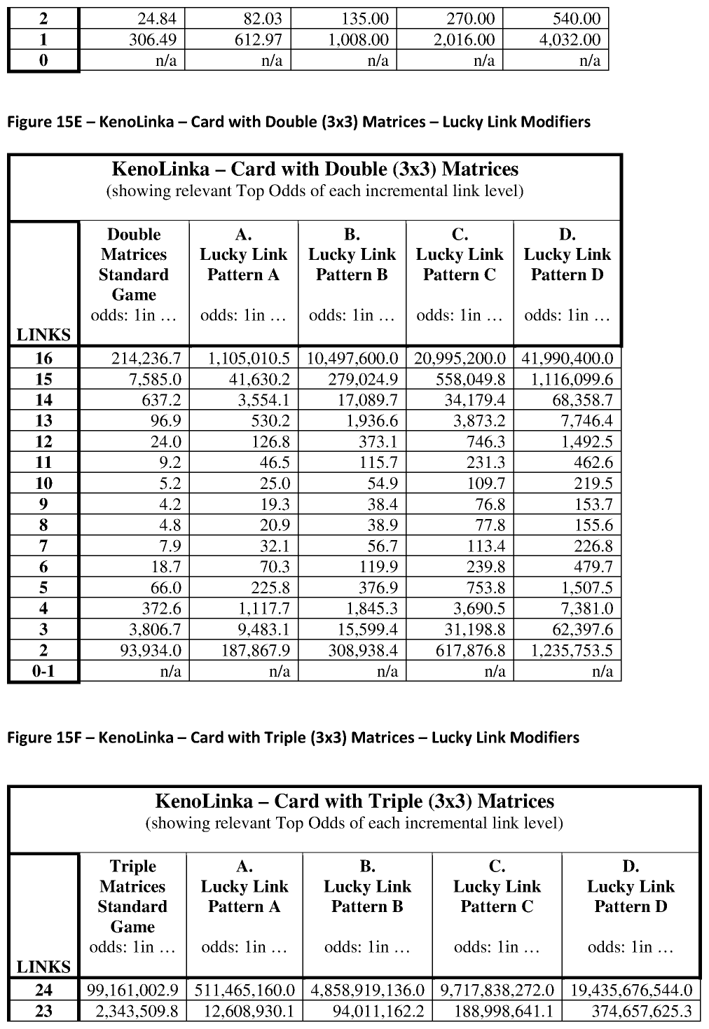

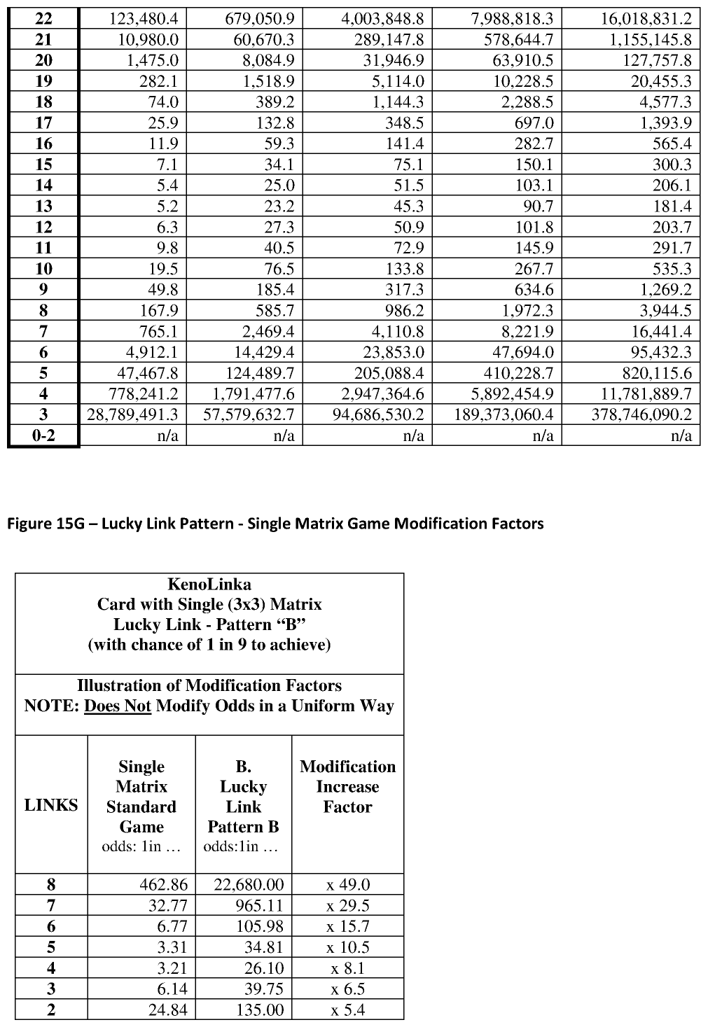

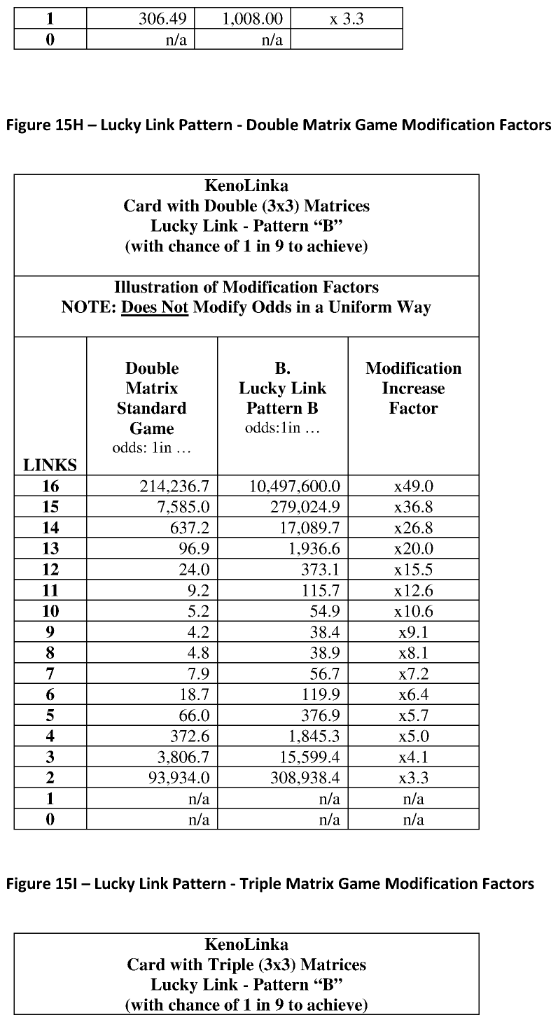

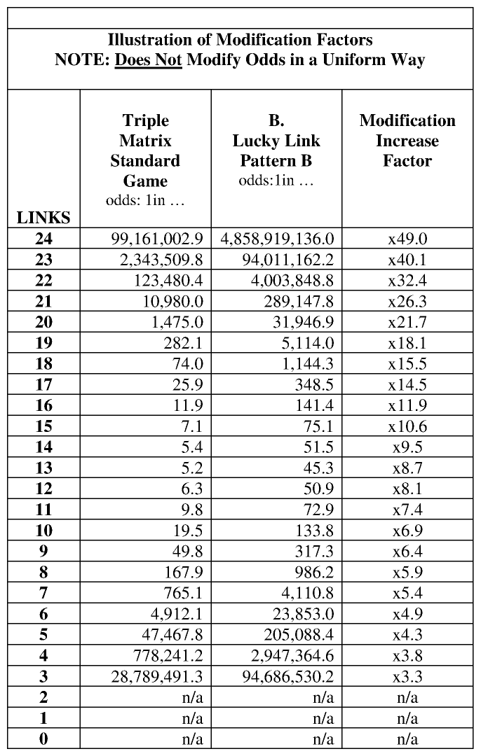

FIG. 15A a is a player entry card having three 3×3 matrices on the card, with one of the matrices showing a pattern in the form of a cross (“+”)

FIG. 15B is a table of the odds for KenoLinka cards with a single 3×3 matrix, a double 3×3 matrix, and a triple 3×3 matrix

FIG. 15C illustrates lucky link patterns for the KenoLinka cards

FIG. 15D is a table of odds for a KenoLinka card having a single 3×3 matrix and the resulting odds of four lucky link modifiers from the patterns in FIG. 15C

FIG. 15E is a table of odds for a KenoLinka card with double 3×3 matrices and the resulting odds of four lucky link modifiers from the patterns in FIG. 15C

FIG. 15F illustrates the same thing with triple 3×3 matrices

FIG. 15G is a table considering the increase factor of the odds for a lucky link pattern in a single matrix game showing non-uniform modification factors

FIG. 15H is a table considering the increase factor of the odds for a lucky link pattern in a double matrix game showing non-uniform modification factors

FIG. 15I is a table considering the increase factor of the odds for a lucky link pattern in a triple matrix game showing non-uniform modification factors

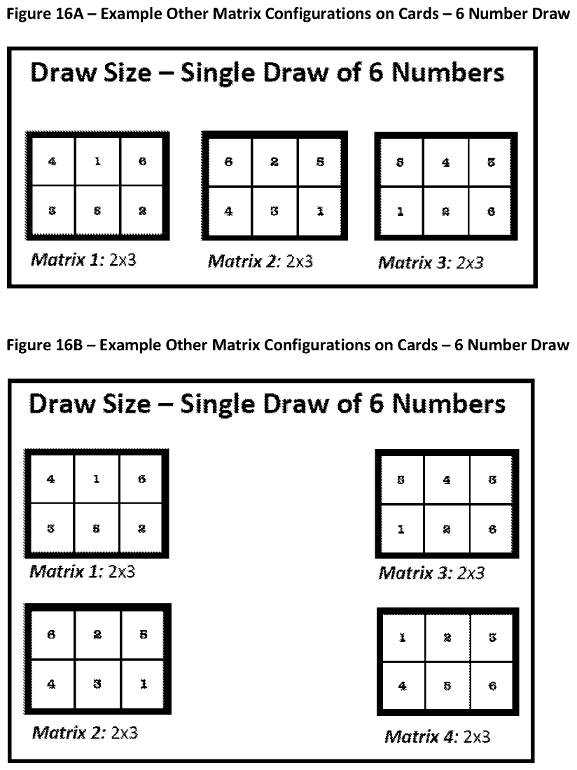

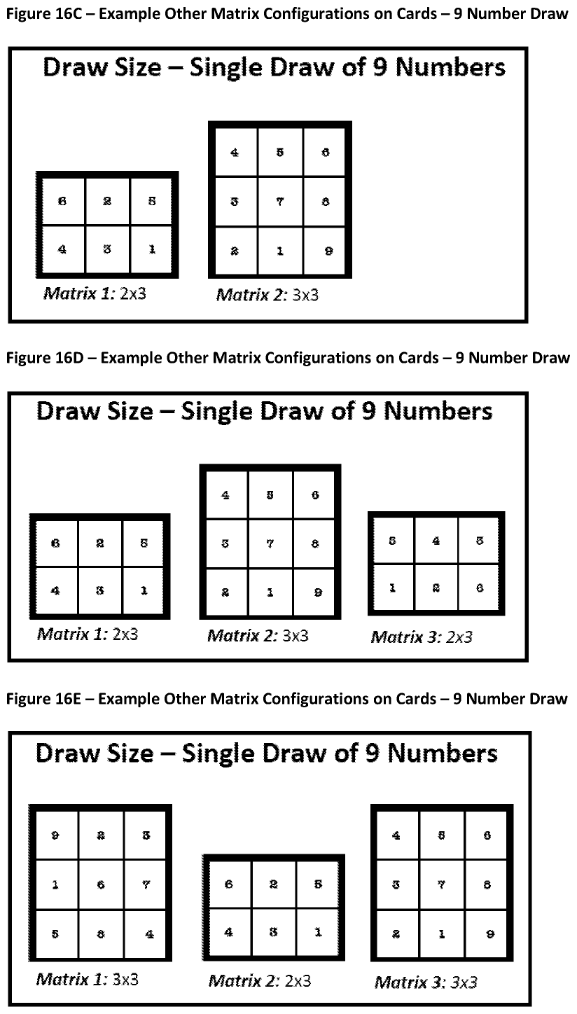

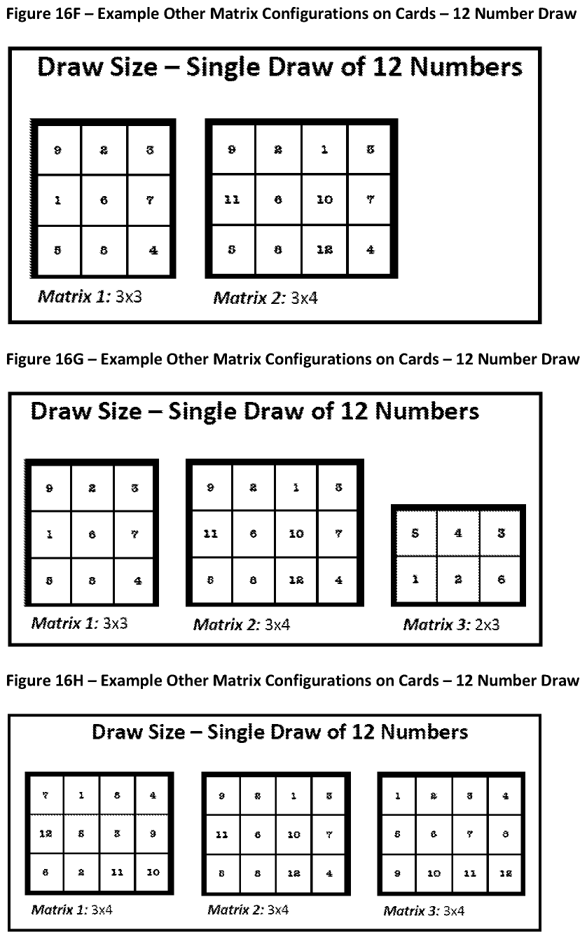

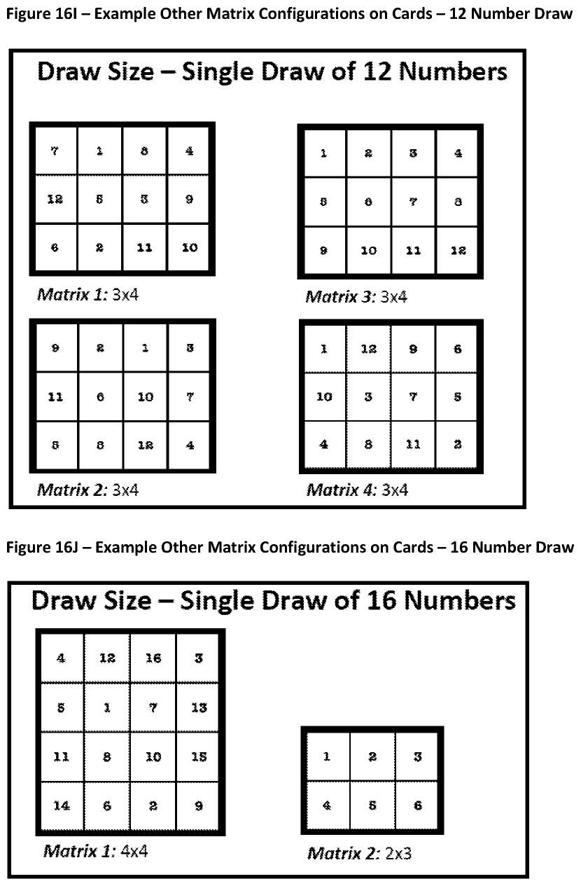

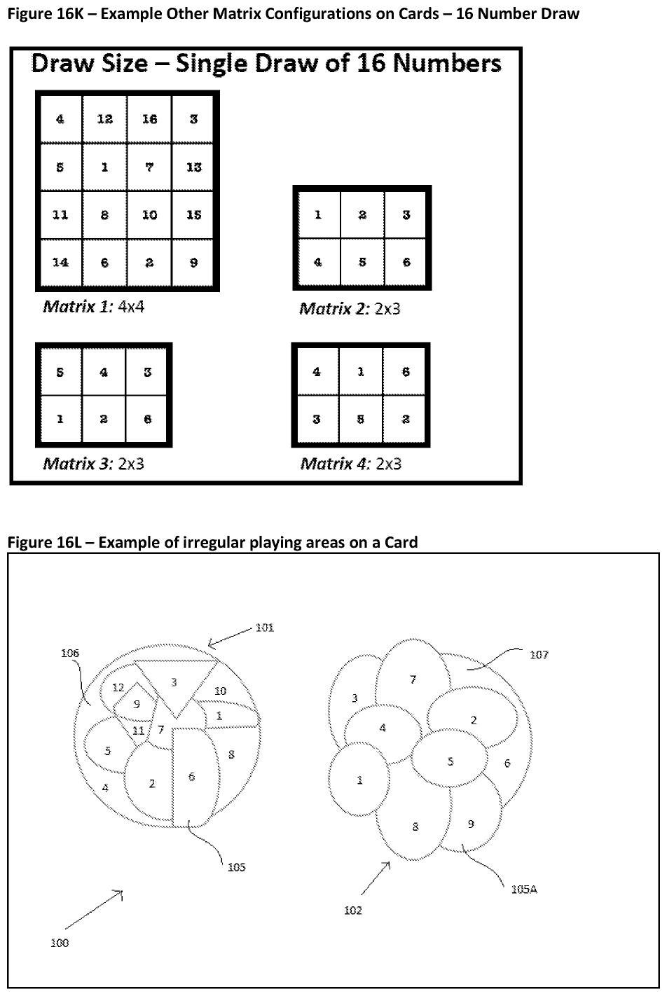

FIG. 16A is an example of the layout of three 2×3 matrices on a card. In these examples, the other information on the card including the space to record the draw sequence has been omitted for the sake of clarity

FIG. 16B is an example of the layout of four 2×3 matrices on a card

FIG. 16C is an example of the layout of matrices of unequal size, in this case one 3×3 matrix alongside one 2×3 matrix

FIG. 16D is another example of matrices of unequal size this time comprising two matrices of 2×3 and one matrix of 3×3

FIG. 16E is a layout in which there are two 3×3 matrices one on either side of a 2×3 matrix

FIG. 16F is an example of a 3×3 matrix alongside a 3×4 matrix

FIG. 16G is an example of a 3×3 matrix alongside a 3×4 matrix then a 2×3 matrix

FIG. 16H shows the layout of three 3×4 matrices

FIG. 16I shows the layout of four 3×4 matrices on the card

FIG. 16J illustrates one 4×4 matrix alongside a 2×3 matrix on a card

FIG. 16K shows a card having a 4×4 matrix and three 2×3 matrices

FIG. 16L is a schematic card having two non-rectangular playing areas each with adjoining or overlapping cells.

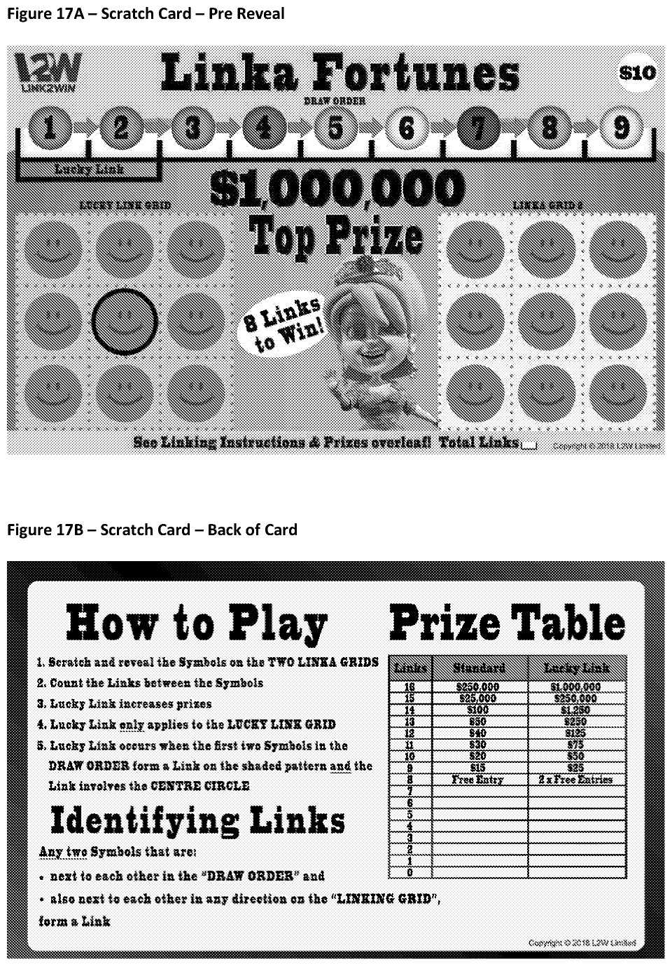

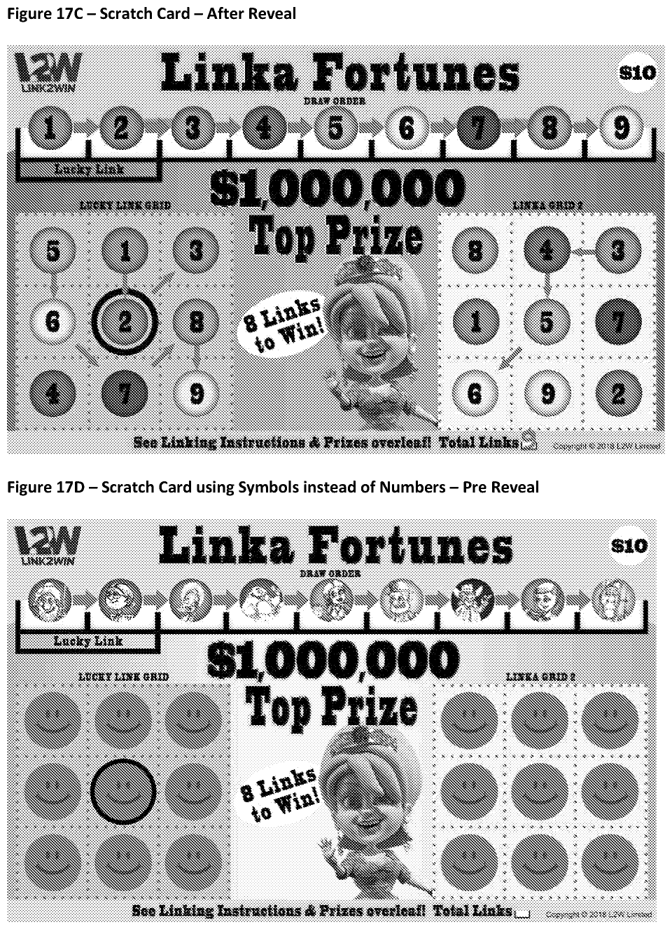

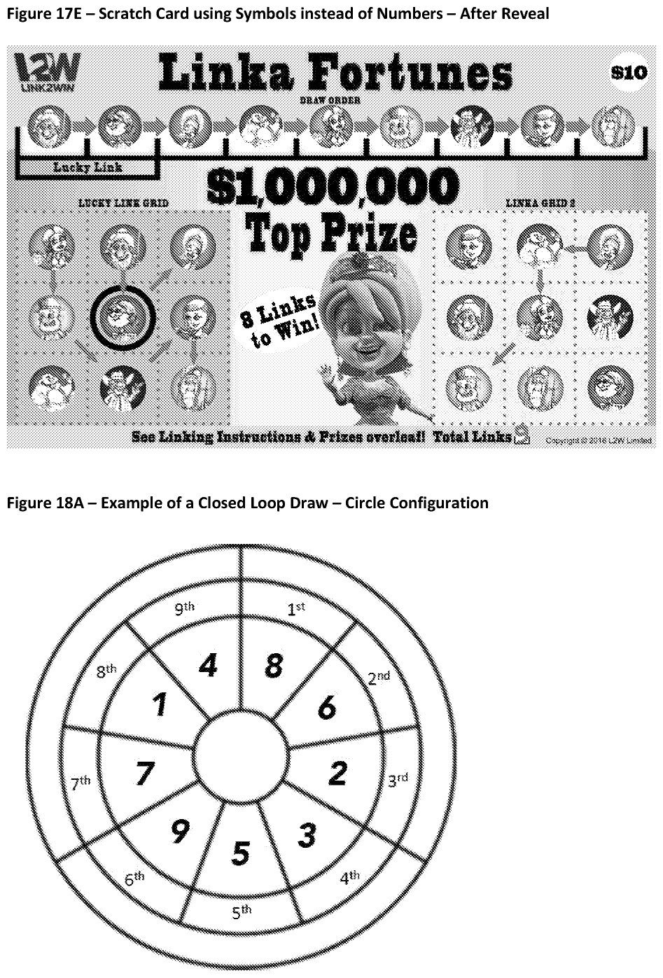

FIG. 17A an example of a scratch card at the point of purchase—the pre-reveal state

FIG. 17B shows the reverse of the scratch card of FIG. 17A

FIG. 17C shows the scratch card of FIG. 17A after the reveal (scratching off the removable layer)

FIG. 18A illustrates how a closed loop draw can be shown in a broadcast, or recorded on a card

FIG. 18B-18C illustrates two other examples of a closed loop draw that can be shown in a broadcast, or recorded on a card

### DESCRIPTION OF THE PREFERRED EMBODIMENT(S)

The following description will describe the invention in relation to preferred embodiments of the invention, namely a set of cards for a lottery using small pool of symbols. The invention is in no way limited to these preferred embodiments as they are purely to exemplify the invention only and that possible variations and modifications would be readily apparent without departing from the scope of the invention.

FIGS. 1 to 5, 7 and 12B, 12C, and 12D show the effects of prior art lottery cards and have been included by way of comparison with the invention

### Overview of the Preferred Embodiments

Described below is a new draw game innovation. In summary, it address and solves all the previously discussed issues, as overviewed and summarised in FIG. 6 (Note: FIG. 6 discusses an exemplary embodiment wherein the pool of numbers comprises 9 numbers):

The sets of cards of this invention can be used for lotteries of different sizes, and can be configured for state lotteries using the land-based retail outlets, in which the cards are printed at the time of purchase by the customer, or they can be pre-printed as for example with the scratch to win type of lottery card in which the draw has already taken place, but the results of the draw are concealed underneath the removable layer on the card.

In both situations the customer does not have the ability to determine or select the layout of the symbols on the matrices, nor does the customer have the ability to influence the random draw of the symbols and hence the number of links on the customers card.

In the state lottery situation where cards are either pre-printed and distributed to the retail outlets, or more likely are printed on demand at a land-based retail outlet when a customer purchases an entry into the lottery and is supplied with a printed card (sometimes called a ticket) displaying the random allocation of the symbols on each of the matrices, the number of possible different permutations of layouts on each matrix or the number of possible permutations of two different layouts on a card together with the increased permutations from the in-game multipliers is sufficiently high that it is unlikely that two players would ever be provided with or have as their entry identical Cards. It is possible that two players may have one matrix layout in common, but it is extremely unlikely that just by chance two players would each have a Card containing the same two identical matrix layouts. Even then it is possible for the software, which controls the printing of the cards, to prevent such an occurrence.

In order to minimise the risk of fraud, it is preferred that in the case of a state lottery that the printing of the cards at the land-based point of sale includes a unique machine-readable code on each card, which machine-readable code and card layouts is stored in a secure database, and the card has other security features, not readily apparent to the customer, which can be used to verify a winning entry, and minimise the risk of fraudulent attempts to print or otherwise recreate a card after the draw has taken place.

It is also possible for the operator of the state lottery to program the various card layouts and to store each of them in a secure database together with a unique key for each of these card layouts, so that the stored layouts can be checked before issuance, to eliminate any possible duplicates. These stored or virtual card layouts can then be disseminated at random to the various land-based retail outlets, and allocated to customers by being printed on demand. If the operator wishes to ensure that a complete set of all possible permutations of card layouts are created and stored in the secure database, then it is preferable that the cards are allocated to the different retail outlets at random, even if the cards have not been created by a random process.

Preferably, the customer has no control over the layout of the symbols on each of the matrices on the card although it is possible that the customer could be allowed to select the position of the layout of symbols on one matrix. (This restriction is necessary because if a customer was allowed to select the position of the layouts of symbols on each of the matrices, then the customer could increase the chances of winning by selecting the same layout positions on both matrices).The completion of the lottery involves the random draw of the symbols and their display in the sequence of their draw, the chance of winning is unpredictable, but the odds table shows that the customer will more likely than not have a large number of Incremental Successes and near win experiences where they'd come very close to gaining enough links to win a prize. For example, FIG. 10, column C shows that in respect of the double matrix (3×3): 19.83% of all outcomes get up to 7 links, and therefore 80.17% of all outcomes get 8 or more links. As one prize scenario example, if prizes were to start at 10 links, then this results in the following outcomes: 35.58% would be prize winners, and 44.58% would have close near wins with 8 or 9 links.

In the case of scratch cards, it is preferable that the required set of cards is pre-printed and that the draw has occurred prior to printing of that set of cards, with a set of cards being seeded with one or more winning cards. Each card is then covered with a suitable removable layer using relevant scratch card technology, where the removable layer is typically a rubberised ink which can be scratched off to reveal the draw, and in this case the links on each of the matrices. Once the scratch cards have been prepared and the winning information has been hidden, the cards then need to be distributed at random to the different retail outlets, since it is the distribution of the cards which is the primary random step of card disbursement so that a customer purchasing a scratch card has no way of knowing whether the card is a possible winning card until he has taken possession of the card and then removed at least part of the removable layer to reveal the outcome.

### Introduction to Link Formation, Base Game Outputs and Odds

In respect of Linka games, the number of Base Game Outputs and the mathematical odds of each output are dependent on the size of the number pool and the corresponding size and shape of the relevant matrices being used.

Preferably, the size of the number pool is equal to the size of the relevant matrix being used in a game (and multiple matrices of the same size do not require any increase in the number pool or to the number of draws). For example, a number pool of 9 numbers can be used in a single game that uses two or more matrices of a 3×3 configuration (each 3×3 matrix having a space for each of the 9 numbers), and the single game is resulted by a single draw of 9 numbers, with such draw used to determine the sum total of links achieved on all the matrices.

Preferably, the rule for forming each link on each relevant matrix is as follows: a link is formed between any two numbers that are:

In sequence in a random draw, and

Are adjacent on the matrix (in any direction).

This rule results in the maximum number of links that can be achieved on each matrix being either:
(i) the same size of the relevant number pool, less 1 (for a game where the draw sequence is shown in a linear line (and not as a Closed Loop Draw)); or
(ii) The same or greater size as the relevant number pool (for a game where the draw sequence is shown as a Closed Loop Draw).

FIG. 9 illustrates how to form links. For this illustration and for simplicity, we use a linka game that uses a pool of 9 numbers and is played using one single 3×3 matrix (though as above, note that the cards of the present invention each comprise at least two matrices). A random draw of the 9 numbers is shown in a linear line and the rules to form links (in this exampled game) are also repeated and set out in FIG. 9. The first link formation is shown (involving numbers 8 and 6). Following the rules to form links, it can be seen that there are 8 links in total, which is the maximum in respect of this exampled game using a linear line draw. However, if in the alternative a Closed Loop Draw as shown in FIG. 18A was to be shown (where the 9^{th} drawn (number 4) would loop back so that it was in sequence with the 1^{st} drawn (number 8)), then an extra link would be formed involving numbers 4 and 8 on the matrix.

### Odds

The odds for linka games have been determined by using Monte Carlo simulations, as the probability of all the different Base Game Outputs from the various matrix sizes and combinations cannot be easily predicted. In respect of a linka game that use a single larger matrix size (such as a single 5×5 or 6×6 matrix) as in our earlier patent specifications, or a linka game that is designed to use the accumulation of links across multi matrices (such as two or more matrices each of a 3×3, 3×4 or 4×4 configurations), the determination of all the outcomes are potentially impossible or at least impractical to do any other way. In the odds tables we have used run sizes of at least 10⁹ (1 billion or more). Examples of run sizes are set out in Table 2 below:

TABLE 2

| Linka Base Game Structure | Ref: | Run Size |
|---|---|---|
| 2 Matrices of 3 × 3: | FIG. 8, column B | 15,983,290,221 |
| 3 Matrices of 3 × 3: | FIG. 15A and 15B | 2,183,879,297,798 |
| 4 Matrices of 3 × 3: | FIG. 14A to 14C | 1,222,080,620,408 |
| 2 Matrices of 3 × 4: | FIG. 8, column D | 11,929,787,273 |
| 1 Matrix of 3 × 4 | FIG. 8, column C | 48,800,000,000 |
| 1 Matrix of 4 × 4 | FIG. 8, column E | 20,922,789,888,000 |
| 1 Matrix of 5 × 5 | FIG. 8, column F | 13,080,318,311,853 |

The importance of undertaking very long run sizes is mainly in respect of Base Game Structures (with and/or without multipliers) where the very top odds are very high so as to more accurately/precisely determine such top odds. For example, the top odds of the 2 matrices of 3×4 have been Monte Carlo determined at 1 in 2,982,446,818 from a total run size of 11,929,787,273 (11.9 billion). This run size produced only 4 top outcomes, which shows that the run size of 11.9 billion is too small to accurately determine the top odds for 2 matrices of 3×4. However, we can sanity check this top odds figure by reference to the top odds for a single matrix of 3×4, which has been very accurately determined at 1 in 51,154.11 from a total run size of 48,800,000,000 (48.8 billion). This run size produced 953,980 outputs at the top outcome level (11 links), which is more than sufficient for very accurate determination of the top odds of a single matrix of 3×4. To then sanity check the expected top odds for 2 matrices of 3×4, this can be checked by undertaking the following squaring calculation: 51,154.11=2,616,742,970. This check is fairly close to the 1 in 2.98 billion figure achieved from the above mentioned run size of 11.9 billion.

Preferably, when determining the top odds of any relevant game by Monte Carlo simulation, the run size should produce at least 1,000 outputs or more at the top odds level.

### Considerations Undertaken for New Draw Game Innovation

It is considered important that for there to be any new draw game innovation, there needs to be a core innovation first, and it must be in respect of an underlying Base Game Structure, and not as may be manipulated by adding in any external non unique add-on features and or additions and or multipliers which can usually be applied to most if not all Base Game Structures, for example such as may be achieved by an additional 1/10 multiplier from an extra number pool (of 10 numbers), with the player selecting one number from that extra pool, and an extra draw of 1 number from that extra pool to result the multiplier.

The considerations undertaken in the development of this new draw game included the following core considerations:

Firstly, the initial considerations were focused on the Base Game Outputs of various Base Game Structures of certain selected and recognised Lotto and Keno games as identified in FIG. 7. These were then considered against the Base Game Outputs of Base Game Structures of selected Linka games as identified in FIG. 8. These initial Linka game considerations were initially of a range of Linka games using number pools ranging from 9 numbers (3×3 matrix) to 25 numbers (5×5 matrix). The preferred Base Game Structure of a Linka game was then selected for comparison against the Base Game Structures and Base Game Outputs of the standard 6/49 Lotto game (that uses a pool of 49 numbers) and the standard Keno games (in particular 8-Spot and 10-Spot Keno) that are played using a pool of 80 numbers. This comparison is set out in FIG. 11.

By way of a further illustrative and visual comparison, the preferred Base Game Outputs of the selected Linka game and the Base Game Outputs of the standard 6/49 Lotto game the 8-Spot and 10-Spot Keno games were each charted to show for each of the four games, the range of outputs and the chances of each output occurring—see FIGS. 12A to 12D.

Three of the features considered as being critical and to be contained within any new Base Game Structure derived from a linka draw game innovation, and for such to be compared against the comparable performance of the existing Base Game Structures of 6/49 Lotto game and existing Keno draw games (for 4, 6, 8 and 10-Spot Keno), the three features being that:
i. the Most Frequently Attained Base Output Level of any such new Base Game Structure must be at a level that is materially greater than the Most Frequently Attained Base Output Level of the existing Base Game Structures of 6/49 Lotto and Keno draw games (for 4, 6, 8 and 10-Spot Keno), with such materiality preferably being at a level that is at least 100% greater, or alternatively, preferably greater by 4 or more Incremental Successes (whichever is the greater). This is achieved by cards of this invention.
ii. there is an overall and mathematically provable greater level of Incremental Successes to be experienced by the entries (players) in any new Base Game Structure derived from a linka draw game innovation; and
iii. a much lower sized number pool is used when compared to that used by the existing Base Game Structures of 6/49 Lotto (which uses a 49 number pool) and Keno draw games (which all use an 80 number pool), with such lower sized number pool preferably being no greater than 16 numbers, but more preferably, no greater than 9 numbers.
iv. A further important feature considered as being very important to be achieved is that any new Base Game Structure derived from a linka draw game innovation must be able to be used with in-game multiplier features to further generate additional outcomes and prize winning opportunities and to generate high top odds that are not less than the top odds in recognized big prize multi jurisdictional lotto draw games, such as in EuroMillions, where the top odds are 1 in 139.8 million, and American PowerBall, where the top odds are 1 in 292.2 million.

Preferably: the top odds are to be in excess of the top odds in EuroMillions and American PowerBall; and with the ability to have frequent winnings of the top prizes; and with design flexibility such that the overall game can be changed to deliver different top odds ranges and other outputs without any change to the underlying Base Game Structure.

### Linka Base Game Structure Considerations

FIG. 8 sets out the base odds comparisons of various Base Game Structures of linka games. The most likely outcome for each is identified with a bolded box around the relevant outcome.

Note: that columns B. and D. in FIG. 8 are the odds outputs for a single game/entry involving 2 matrices, where the number of links from both matrices (that are each resulted from the same single draw) are totalled and each output is individually considered to produce the overall Base Game Outputs.

### Consideration of Single Matrix Base Game Structure

As can be seen from FIG. 8, the single matrix Base Game Structures (columns A, C, E and F) produce as their most common outputs a relatively static 4-5 links even though the number pool increases from 9 to 25 and the top odds decrease from 1 in 462.9 to over 1 in 3.9 billion, and even though the corresponding range of Base Game Outputs increases from 8 links (column A) to 24 links (column F).

The above shows that while increasing the size of the underling linka game derived from any Base Game Structure using a single matrix does significantly increases the top odds and the total number of Base Game Outputs, the draw backs when increasing the size are the use of an increased number pool and, as can be seen by reference to the single matrix Base Game Structures set out in columns A, C, E and F, increasing the size of the underling game derived from a Base Game Structure using a single matrix does not materially add to or increase the levels of player engagements that are generally experienced by the majority of players of such games as there is no material corresponding increase to the level or number of Incremental Successes.

When increasing the size of a game, the above discussed issue of there not being a correspondingly similar level of increase to the Incremental Successes to be experienced by the majority of players also exists in the Base Game Structure of all recognised Lotto and Keno draw games, and this can be seen in the Base Game Structures for the Lotto and Keno games identified in FIG. 7, where the increase in the size of the game does not result in any material corresponding increase to the level or number of Incremental Successes. FIG. 7 shows that there is no increase to the Incremental Successes in the exampled Lotto games (when increasing the size of the Lotto game from 6/49 (with top odds of 1 in 14 million) to 6/59 (with top odds increasing to 1 in 45 million), and that in respect of increasing the game size of the exampled Keno games (where the top odds increase from 1 in 326 to 1 in 8,911,711): there is no increase to the Incremental Successes when increasing from 4 Spot to 6 Spot Keno; there is an increase by 1 match to the Incremental Successes when increasing from 6 Spot to 8 Spot Keno; and there is no increase to the Incremental Successes when increasing from 8 Spot to 10 Spot Keno.

As mentioned previously, and summarised again, the three features considered as being critical and to be contained within any new Base Game Structure derived from any linka draw game innovation are that:
i. the Most Frequently Attained Base Output Level of any such new Base Game Structure must be at a level that is materially greater than in existing Base Game Structures of 6/49 Lotto and Keno draw games, with such materiality preferably being at a level that is at least 100% greater, or alternatively, preferably greater by 4 or more Incremental Successes (whichever is the greater); and
ii. there is an overall and mathematically provable greater level of Incremental Successes; and
iii. a much lower sized number pool is used, preferably being no greater than 16 numbers, but more preferably, no greater than 9 numbers.

While the single matrix Base Game Structures (FIG. 8, columns A, C, E and F) do have greater levels of Incremental Successes and a higher Most Frequently Attained Base Output Level when compared to the considered and comparable Lotto and or Keno Base Game Structures, they do not compare to the remarkable outputs of the two matrix Base Game Structures, which are addressed below.

### The Two Matrix Base Game Structures

The two matrix Base Game Structures as set out in columns B. and D. of FIG. 8 produce as their Most Frequently Attained Base Output Level 9 and 10 links respectively, with each having extremely high levels of Incremental Successes (which can be determined by an upward analysis of the odds for each relevant output, starting at 0 links—see FIG. 10) achieved using a single low number pool of 9 and 12 numbers respectively, with top odds of 1 in 214,236.7 (from the 9 number pool game) to 1 in 2.6 billion (from the 12 number pool game).

The range of Base Game Outputs is also superior to the relevant single matrix game using the same number pool size, with the 9 and 12 number pool games having respectively 16 and 22 Base Game Outputs (compared to 8 and 11).

Importantly, both these two matrix Base Game Structures have extremely slim chances of getting game outcomes with only a low level of Incremental Successes, as in respect of both these Base Game Structures, it is almost certain, based on the probabilities, that the number of Incremental Successes in each will be 6 links or more, as this occurs respectively on the probabilities, 98.19% and 97.91% of the time, which can be determined by reference to FIG. 10.

In comparison, in respect of the single 4×4 matrix Base Game Structure using a number pool of 16 numbers as set out in column E. of FIG. 8, while the range of Base Game Outputs (at 16 (being 0-15 links)) is similar to the range of Base Game Outputs (at 17) of the two 3×3 matrix Base Game Structure, it otherwise has very different and inferior levels of Incremental Successes, including a much lower Most Frequently Attained Base Output Level (at 5 links as opposed to 9). Further, based on the probabilities that the number of Incremental Successes will be 6 or more links, this occurs for the single 4×4 matrix game 43.34% of the time, which is much lower than the 98.19% outputted by the two 3×3 matrix Base Game Structure—this can be determined by reference to FIG. 10.

In these important respects, the single 4×4 matrix Base Game Structure is significantly inferior to the two 3×3 matrix Base Game Structure. Further, it uses a number pool size of 16, which is 1.8× greater than the 9 number pool used in the two 3×3 matrix Base Game Structure. Accordingly, and because the two 3×3 matrix Base Game Structure is capable of very high odds (with the use of in game multipliers and no additional draw (or if with an additional draw, then also of a low number set), as discussed later) the single 4×4 matrix Base Game Structure is not part of this invention.

### EXAMPLE 1

A first example is a card having a single 3×3 matrix as shown in FIG. 9 (for illustrative purposes only). This has a maximum of 8 links and an odds table as shown in the first column of FIG. 8 with each player always having at least one link and with the most probably outcome being 4 or 5 links. This avoids the dissatisfaction of players in Keno or Lotto games where they do not get any “hits”. The curved nature of the odds table means that prizes can be allocated for cards having 6, 7, or 8 links. Though it will be noted that if a player reaches 4 or 5 links which is a relatively common occurrence they will believe they are close to winning, the “near win experience”.

Leaving aside the possibility of prize multipliers or additional choices by the customer, the Base Game Structure involves: one number pool of nine numbers; the nine numbers distributed in different locations on the 3×3 matrix; there is one random draw involving those nine numbers used to result the game; and the formation of links follows the method set out in FIG. 9. This exemplary card contains the playing area (the 3×3 matrix) together with linear section to record the results of the draw and instructions on how links can be formed. In practice the card will also have a Machine readable ID and/or other security information to minimise the risk of fraud.

The draw can either be a linear draw or a Closed Loop Draw. For example with nine symbols drawn one after the other and displayed in a single line (this is called a linear draw) there is a maximum number of eight potential links on a matrix using the linking rules set out in FIG. 9. Whereas with a Closed Loop Draw in which the numbers drawn complete: a circle configuration, there are a possibility of nine links (see FIG. 18A); or some other closed configuration then there is the possibility of more than nine links depending on the relevant game rules (see such example in FIG. 18B)

### EXAMPLE 2—Preferred Base Game Structure

The preferred card layout is shown in FIGS. 13A to 13N.

The two 3×3 matrix Base Game Structure as set out in column B of FIG. 8 is preferred over the two 3×4 matrix Base Game Structure as set out in column D as:
i. it uses a much lower number pool and draw size, using a pool size and draw of just 9 numbers, as opposed to 12;
ii. from a Base Game Structure level, while it has 16 Base Game Outputs (compared to the 22 outputs of the two 3×4 matrix Base Game Structure) it is not under any disadvantage as it has almost the same Most Frequently Attained Output (being 9 as opposed to 10), a greater percentage of outcomes with 6 or more links (98.19% of the time versus 97.91%) and it has the ability to increase the outputs and outcomes with the use of in game multipliers;
iii. it is a game that will always result in at least 2 or more links (because each 3×3 matrix, as a consequence of its configuration, must always have at least 1 link involving the middle square) which assists in enhancing the player experience of Incremental Successes; and
iv. its starting top odds are more useful, being odds of 1 in 214,236.7, compared to the top odds of the two 3×4 matrix Base Game Structure of 1 in 2.6 billion, which are top odds that materially exceed any foreseeable requirements.

For the reasons set out, this two matrix Base Game Structure, as set out in columns B of FIG. 8, is the preferred Base Game Structure for a new Linka draw game innovation.

### Comparing Base Game Structures—Lotto & Keno Vs Preferred Linka

FIG. 11 sets out the base odds comparisons of various Base Game Structures for: 6/49 lotto; 8-Spot and 10-Spot Keno; and the preferred new Base Game Structure for a new Linka draw game. The Most Frequently Attained Base Output Level for each Base Game Structure in FIG. 11 is identified with a bolded box around the relevant outcome.

As can be seen from FIG. 11, when compared against the Base Game Structures of the Lotto and Keno draw games (set out in columns A. to C.), the preferred Linka Base Game Structures produces, in all cases, significantly increased Incremental Successes, with 98.19% of all outcomes getting 6 Incremental Successes or more (being 6 links or more).

### Reason for the Outstanding Output

While the Base Game Structures of the single matrix linka games produce increased levels of Incremental Successes when compared to comparable Lotto and Keno games, it was not initially appreciated that the number and makeup of Incremental Successes arising from a single game using two (or more) matrices as described above, would result in the outstanding outputs as described above. These outputs are exceptional and they can be further enhanced by the use of in game multipliers.

By way of explanation and using the change in odds and outcomes from a single 3×3 matrix to a double 3×3 matrix, the very top and very bottom odds have been compounded (by a squaring factor) which has a huge effect on both ends of the odds spectrum, decreasing exponentially the relevant top and bottom odds. This effect is still felt but is not as great for the second top and bottom odds. However, as this consideration moves towards the middle of the odds table, these middle odds are generally unaffected and display odds levels that are comparable with the single matrix. This effect is demonstrated in Table 3 below.

Note: The Illustrative Increase Factor shown in column E of Table 3 is, as described, illustrative only as it is difficult to undertake exact comparisons. For example, taking the 4 Link/8 & 9 Links comparison in the centre of the table (identified with a bolded border), while the 8 and 9 links outcomes in the two matrices are shown at odds of 1 in 4.8 and 1 in 4.2 respectively, if these odds were to be combined so as to better equate to the odds of 1 in 3.2 in the single matrix, the combined odds of getting 8 or 9 links would reduce the face value of the odds to 1 in 2.2, thereby resulting in a decrease factor (being less than 1) of 0.69×.

TABLE 3
Illustrative Odds Increase Factor
1 Matrix (3 × 3) Vs 2 Matrices (3 × 3)

| | B. | | D. | E. |
|---|---|---|---|---|
| | 1 Matrix | | 2 Matrices | Illustrative |
| A. | (3 × 3) | C. | (3 × 3) | Increase |
| Links | Odds 1 in . . . | Links | Odds 1 in . . . | Factor |
| 8 | 462.9 | 16 | 214,236.7 | 462.9x |
| 7 | 32.8 | 15 | 7,585.0 | 231.3x |
| | | 14 | 637.2 | 19.4x |
| 6 | 6.8 | 13 | 96.9 | 14.3x |
| | | 12 | 24.0 | 3.5x |
| 5 | 3.3 | 11 | 9.2 | 2.8x |
| | | 10 | 5.2 | 1.6x |
| 4 | 3.2 | 9 | 4.2 | 1.3x |
| | | 8 | 4.8 | 1.5x |
| 3 | 6.1 | 7 | 7.9 | 1.3x |
| | | 6 | 18.7 | 3.1x |
| 2 | 24.8 | 5 | 66.0 | 2.7x |
| | | 4 | 372.6 | 15.4x |
| 1 | 306.5 | 3 | 3,806.7 | 12.4x (or |
| | | | | 153.5x) |
| | | 2 | 93,934.0 | 306.5x |
| 0 | Never 0 | 1 | Never 1 | n/a |
| | | 0 | Never 0 | n/a |

### Design of the New Linka Draw Game

The design specifications of the new Linka draw game innovation are based on the preferred Base Game Structure. The core specifications are set out in Table 4 below:

TABLE 4
New Linka Draw Game - Core Specifications
Base Game Structure

| | |
|---|---|
| Number Pool/s | Single pool of 9 numbers |
| Draw | Resulted by a single draw of 9 numbers |
| Number of Matrices | Two matrices |
| Matrix Sizes | 3 × 3 and 3 × 3 |
| Matrix population | Each matrix is randomly populated with 9 numbers |
| | (1-9) |
| Draw Reveal Type | By linear draw |
| Game Objective | To accumulate links on the two matrices and to win |
| | prizes based on the number of links achieved. |
| Forming each Link | According with the rules set out in FIG. 9. |
| Number of Base Game | There are 17 in total, being 0-16 links, although it |
| Outputs | is not possible to have a game outcome that |
| | achieves just 0 or 1 link. |

In Game Multipliers

| | |
|---|---|
| Multiplier 1 | Lucky Link Multiplier: |
| | This multiplier is achieved on any one or both of |
| | the two matrices. It occurs when the 1^{st} two drawn |
| | numbers in the draw undertaken to result the game |
| | result in a link being achieved on one matrix or both |
| | matrices in accordance with the rules set out in |
| | FIG. 9, and where such link/s involves the |
| | middle square of the matrix/matrices. |
| Multiplier 2 | Pick 2 Multiplier: |
| | The “Pick 2” numbers are randomly allocated when |
| | entering the game, with an allocation of 2 numbers |
| | in order from 9. The aim for the player is to have |
| | the 2 numbers in order based on what the order of |
| | the 8^{th} and 9^{th} drawn numbers are going to be. |
| | This Pick 2 multiplier operates when the 8^{th} and 9^{th} |
| | drawn numbers match in correct order the Pick 2 |
| | numbers allocated to the player. |
| | The odds of achieving this event are 1 in 72. |

Odds and Outcomes

| | |
|---|---|
| Outcomes | There are 3 core outcomes (A, B, or C) and each |
| | core outcome has one of 2 sub-outcomes, all of |
| | which are set out in FIG. 13P. |
| | Firstly, the 3 core outcomes are: |
| | i. 0 Lucky Links (A); or |
| | ii. 1 Lucky Link (B); or |
| | iii. 2 Lucky Links (C). |
| | A player will end up in one of these 3 core |
| | outcomes following the 1^{st} 2 numbers being drawn, |
| | which determines how many Lucky Links are |
| | achieved and which of the 3 core outcomes applies |
| | (either A for 0 Lucky Links; B for 1 Lucky Links; |
| | or C for 2 Lucky Links). |
| | Then in respect of each of the 3 core outcomes, each |
| | has 2 outcomes, either “with” or “without” the |
| | achievement of Multiplier 2 (the player's Pick 2 |
| | multiplier). |
| Number of Total | There are 102 in total (being 17 Base Game Outputs × |
| Game Outputs | 6 (being 3 core outcomes, each with 2 sub |
| | outcomes). |
| Odds | The odds of each of the 102 outputs are set out in |
| | FIG. 13P. Note: 12 outcomes relate to 0 or 1 |
| | Link, which will never be achieved as an end game |
| | result for the reasons discussed previously. |
| Prizes | Exampled prizes are set out in FIG. 13O. |

This game is played on an entry Card (FIGS. 13A and 13B) where the two matrices are randomly populated at the POS at the time of entry, including randomly allocating the Pick 2 multiplier, or as may be hidden at the time of purchase such as in a scratch card.

In this exampled game, it is not an option for the player to select the Pick 2 multiplier with knowledge of the order in which the two matrices are or have been populated as this would allow players to improve their chances to win the very top jackpot prize by choosing Pick 2 numbers that were: (a) not contained in the centre squares of the matrices; and (b) located next to each other on each of the matrices (and which therefore could form links, for example such as the location of numbers 2 & 3 or 6 & 8 on the two matrices contained in FIG. 13A).

This exampled game can allow the player to select the Pick 2 multiplier, but only if the player is committed to the entry and only without knowledge of the position of the numbers on the two matrices.

This game can be modified slightly to allow for the player to select the Pick 2 modifier with the knowledge of the position of the numbers on the two matrices, with such modification involving a second draw of 2/9. In this event there would need to be new Monte Carlo simulations run to determine any change in the odds (in particular the top odds) as set out in FIG. 13P.

In all other respects, the operation of this new draw game can be determined from FIGS. 13A to 13S.

FIG. 13 A shows the player entry card, before play commences. This is the type of card that will be printed at a retail outlet of a state lottery. If the point of entry player pays for his card and picks two of the numbers before the card is printed, then these numbers can appear on the card on the right-hand side as shown in FIG. 13A (here “2 & 7”).

The face of the card has a machine-readable code at the top left for security and identity purposes, it has a linear sequence of cells to enable the player to record the draw in order of the numbers drawn, to assist the player in then identifying and recording the links in the two playing areas. The playing areas comprise two 3×3 matrices, with individual numbers appearing once only on each matrix, and with the layout of the numbers on the matrices being randomly achieved, with the numbers appearing in different positions on the different matrices. There are a number of different ways of achieving such layouts, and whilst epos makes it possible to randomly generate these layouts at the point of sale, it is preferable that the layouts are pre-established, and stored in a central server, and then distributed to the retail outlets as needed so that the distribution of the layouts to customers is in itself a random process. On the face of the card there is provision for the player to record the results of the number of links, and any other price multiplier consistent with the prizes and instructions for that particular lottery. The reverse of the card is shown in FIG. 13B, and this may include instructions on how to play the lottery, and the different possible price tables applicable to that lottery. FIG. 13C shows the draw result where the numbers have been drawn at random, and information disseminated to players by all usual means including radio or television broadcasts, the Internet, in some cases text or instant messaging, or being printed in newspapers or other periodicals. Using this information the player can then start to identify and record links on the matrices. At this point the player will realise that their PICK 2 was successful as heir PICK 2 numbers are matched in order with the last two numbers drawn.

The player will also have identified that the central cells contain numbers five and four which were drawn first and second, meaning that the player will achieve a total of two Lucky Links.

FIG. 13E shows the player marking up the links between adjacent cells on the matrices containing the numbers five and four. It does not matter the order in which these first two numbers have been drawn so long as those two numbers appear in adjacent cells on a matrix. Since these two numbers are designated as lucky links, the player has identified two lucky links, one on each matrix.

FIG. 13F shows the player then looking for links between the second and third numbers drawn, namely number four and number three. The player is looking for situations on each matrix where those numbers appear in adjoining cells. They are both in adjoining cells on each matrix, so the player can mark these two links by arrows as shown in FIG. 13F.

FIG. 13G repeats the process in which the next sequential numbers in the record of the draw (numbers 3 and 9) are then located on the matrices. In this case there is an additional link on matrix one but no possibility of a link on matrix two as the numbers three and nine on matrix two are not in adjacent cells.

FIG. 13H shows the application of the fourth and fifth numbers drawn in the sequence (number 9 and 1), and once again there is an additional link on matrix one but no additional link on matrix two. FIGS. 13I, J, and K continue the process with FIG. 13L showing the application of the last two numbers drawn to the matrices but with no additional links for this final stage.

In FIG. 13M the final result is able to be shown on the player card. The player is able to record that on matrix one there were seven links on matrix two there were only three links giving a total number of links of 10 which can be recorded at the bottom of the card. In addition, the player can record the two lucky links which were identified in FIG. 13E, and can also record that their PICK 2 was also successful.

FIG. 13N shows this result information from FIG. 13M applied to the reverse of the card and to the prize table shown, so the player can work out the total price won based on the rules of the lottery.

FIG. 13O shows the price table which has been expanded for clarity.

FIG. 13P shows the odds table based on the number of lucky links (outcomes a, B, or C), and to each outcome whether or not the PICK 2 applies.

FIG. 13Q shows a jackpot distribution draw, this is an optional feature to retain player engagement. In the event that a jackpot is not won by a certain stage, it provides players with a second chance of winning the accumulated cash in the top prize tier, and the jackpot distribution entries shown on the reverse of the card in FIG. 13R (and 13B).

FIG. 13S shows an example result for player A. This player is successful, along with about 37 other players in winning a prize as shown in the drawing, with all successful players qualifying for the final single winner stage to win the available jackpot prize.

FIG. 13T shows how to achieve a final single winner of the available jackpot prize.

### EXAMPLE 3

This involves a card having four 3×3 matrices preferably side-by-side as shown in FIG. 14A.

The card is similar to that of FIG. 13A, having provision for recording the draw sequence, and allowing the players to mark the number of links on each of the matrices based on the draw.

Reverse of the card shown in FIG. 14B is somewhat different to FIG. 13B as this allows for prizes based on how many of the matrices on the card have the same number of links at the end of the game. Thus the prize table is based on both the number of links achieved on each matrix (note this is not additive across the matrices) and the number of matrices had having the same number of links.

This information is expanded in FIG. 14D, and FIG. 14C shows the odds of achieving the same number of links on each card.

FIG. 14E shows the draw result which is then recorded on the card at FIG. 14F.

FIGS. 14G-14N show the snapshots of the card as a player looks for and enters links on each of the matrices following the rules of the game.

FIG. 14O shows the player recording the number of links on the different matrices showing that the first matrix and the last matrix have the same number of links (5 links each).

FIG. 14P shows the reverse of the card with a player entering this outcome but showing that the player has not won a prize but came very close to doing so and achieved a “quite near win experience” as the player needed three matrices with five links to win a prize. The player had two matrices with five links and the fact that the third matrix had six links would suggest to the player that they came close to winning a prize, if only the third matrix had stopped at five links.

### EXAMPLE 4

This is the KenoLinka type of game which is illustrated in FIGS. 15A-15I.

This KenoLinka game has large player choice, with a number of sub games, all resulted from one draw of 9 numbers. This choice is similar to that available in the Keno games in set out in FIGS. 4A and 4B where Keno players can select to play differing Spots, for example 4 Spot, or 5 Spot, or 10 Spot Keno, all of which can be resulted by the one draw of 20 numbers from 80.

It has been given the name KenoLinka because it is a draw game that has player choice and because it has some similarity with the odds profile of the Keno games.

FIG. 15A shows a player entry card having three 3×3 matrices but with one of the three matrices having a lucky link pattern in the form of a cross. FIG. 15B shows the Standard Base Odds for each of a card with: one 3×3 matrix; two 3×3 matrices; and three 3×3 matrices.

FIG. 15C shows the lucky link patterns (which act as multipliers to increase odds and outcomes) and gives four different examples of such patterns labelled A, B, C and D, and the odds of achieving a selected pattern, being odds of 1 in 4.5 for pattern A to 1 in 36 for pattern D. One lucky link pattern is contained on each Card and it is contained on only one matrix on the Card—for example see FIG. 15A. In this example of the game, a lucky link is achieved when the last two drawn numbers (the 8^{th} & 9^{th}) form a link on the matrix containing the pattern and where that link covers the centre cell and another square in the pattern, designated in FIG. 15C and marked with a small “X” (the lucky link can be made in any direction).

FIG. 15D gives the possible number of links and the odds for a card with a single 3×3 matrix and the odds that arise for each of the lucky link modifiers. The changes and increases in the odds from pattern A-D arise as a consequence of the differences in the patterns shown in FIG. 15C. Broadly speaking, achieving a lucky link increases the top odds of the relevant standard game by an irregular amount, as follows:

Pattern A, by 5×—similar to the odds of getting pattern A (1 in 4.5);

Pattern B, by 50×;—not similar to the odds of getting pattern B (1 in 9)

Pattern C, by 100×;—not similar to the odds of getting pattern C (1 in 18)

Pattern D, by 200×—not similar to the odds of getting pattern D (1 in 36)

Excluding pattern A, achieving the maximum number of links on each of the other patterns B-D is about 5× harder than the associated odds of getting the pattern. This is because patterns B-D do not allow for a lucky link involving the middle square and a corner, but only allow a bar link, like that shown in pattern D. As a consequence it becomes much more difficult to achieve the top number of 8 Links on the Card. In essence the use of a bar pattern restricts the number of top link outcomes.

As an illustrative example, lucky link with pattern “B” is an event that will happen on average 1 game out of every 9. While the odds of achieving this lucky link are 1 in 9, this modifier's occurrence is not independent of the number of links formed. If it were independent, then the odds of getting any number of links in combination with getting the lucky link with pattern B would be nine times harder. The table in FIG. 15G sets out the actual “Increase Factor” for a Card with a single matrix and arising from pattern B, for each level of links. Likewise, FIGS. 15H and 15I sets this out for Cards with two and three matrices.

This creates a striking advantage: it provides comparatively good chances for players to achieve the extra win (1 in 9 for pattern B), and it makes the top outcome of 8 Links much harder to achieve (1 in 49), thus allowing the operator to offer a much bigger top prize than would otherwise be able to be done. This is a unique factor, which flows throughout the KenoLinka number games.

FIG. 15E illustrates the odds for a card with two 3×3 grids and lucky link modifiers. Likewise FIG. 15F shows the same layout of odds but with three matrices and the lucky link modifiers.

FIGS. 15G, H and I show the effect of lucky link pattern B (as a selected pattern example) on the different games.

### EXAMPLE 5

FIGS. 16A to 16K show a number of different types of layouts, with the cards being simplified to show only the layouts and omitting the other information on the card as shown for example in FIG. 13A.

FIG. 16A and 16B show equal matrices based on a 2×3 matrix, with a single draw of six numbers giving 15 possible links for the card of FIG. 16A and 20 possible links for the card of FIG. 16B.

FIG. 16C-16G and 16J and 16K show cards having unequal matrices. It is not necessary to explain each of these in detail other than to note that if in the case of FIG. 16C the two matrices are of unequal size, the pool of available symbols needs to match the number of symbols on the larger matrix. In this case there needs to be a set of nine numbers to allow for the second matrix which is a 3×3 to be fully populated. But this means that the first matrix which is only at 2×3 matrix, will have some of the numbers of the set but not all. When the numbers are drawn, there is a greater probability of achieving links on the larger matrix than there is on the smaller matrix. For example if the numbers are drawn in the order seven then one, the player can mark a link on the larger matrix but cannot possibly mark a link on the smaller matrix, as the number seven does not appear on the smaller matrix. Thus the attempts at creating links on the smaller matrix will be discontinuous, and most likely be unsatisfactory to the player.

Nevertheless these cards with unequal matrices have been included to show that with a linear draw, for example the card of FIG. 16C would have a maximum number of 5+8 links, i.e. 13 links, although the chance of achieving all 13 links is extremely unlikely because of the highly probable discontinuous nature of the draw affecting the possibility of links on the smaller matrix.

FIGS. 16F-16K show possible configurations with draw sizes either 12 or 16 numbers.

FIG. 16L shows a card with two irregular playing areas, and the other card information omitted. The overall playing areas are essentially circular in layout with a number of adjoining cells each of a non-standard shape. Each of these cells has a number of adjoining cells and hence a number of possible links that can be created if the symbols located in the cells are drawn in sequence in the lottery draw.

In this example, the playing area 102 on the right of the card has for example 9 cells but the odds of achieving the different number of links on each of these matrices will differ from that of the more regular 3×3 matrix described above in FIG. 9 or 13A.

This drawing has been included to show that the game can be played with cards having unusual playing areas, so long as a majority of the cells in that playing area have three or more neighbours. The playing areas need not be the same shape or size and need not have the same number of cells.

Card 100 shows only the two playing areas (as the other card information has been omitted for ease of explanation). It has two irregular playing areas 101 and 102. Area 101 has 12 “cells” one of which is labelled 105 (in this case irregular areas separated from other “cells” by boundary lines), and another 106. Each cell contains a symbol, in this case a numeral from 1-12.

These numerals will be drawn at random during the lottery to determine if links can be recorded on the playing areas as described above. Playing area 102 has a different shape and different number of cells, one of which is labelled 105A and another is labelled 107. Most cells in each playing area have at least 3 neighbours. For example cell 105 is bounded by the cells containing numbers 2, 7, 8 and arguably the cell containing the numeral 1—this shows a problem with these irregular layouts as the layouts need to be unambiguous in terms of neighbouring cells—hence requiring more time in their preparation for printing than the much simpler rectangular matrices of cells described above.

Cells 106 and 107 illustrate an advantage of this irregular layout in that these two cells around the periphery of the playing areas can potentially have a large number of neighbouring cells. For example cell 106 contains the number 4 and has neighbouring cells containing the numbers 2, 5, 11 (at one vertex of this cell), 12, 9 (at vertex), 3 and 10 (at one vertex of this cell). Cell 107 has fewer neighbours but still more than 3 neighbours.

Since playing area 101 has more cells than playing area 102, 11 cells compared to 9 cells, this means that the numbers drawn are preferably from 1 to 11 allowing for a full contingent of links in area 101 but giving rise to discontinuities in play of area 102 when numbers 10 or 11 are drawn. Conversely the numbers drawn could be the smaller set of 9 numbers creating a discontinuity in the play of area 101.

### EXAMPLE 6

FIGS. 17A-17C show a scratch to win card. FIG. 17A shows the card prior to the reveal state, i.e. with the draw revealed on the face of the card at the time of purchase, but the layout of the numbers on the matrices not disclosed.

FIG. 17B shows the reverse of the card with the instructions on how to play the game and the resulting prize table.

FIG. 17C is the reveal state after the player has removed the removable layer, typically by scratching off a rubberised ink, and then calculating the number of possible links. In this case the player has won a prize because they have achieved nine links and one lucky link.

FIGS. 17D and 17E show another example of a scratch card, but instead of numbers, it uses symbols.

### EXAMPLE 7

FIG. 18A shows a display of a Closed Loop Draw in place of the linear draw used on the cards in the other figures. The Closed Loop Draw has the advantage that there will be an additional link if the playing area has two adjacent cells matching the last number drawn and the first number drawn. In other words in this example of a Closed Loop Draw, it has the advantage of giving up to nine links for a 3×3 matrix, but the disadvantage that it takes up more space on the card.

FIGS. 18B and 18C illustrate alternative loop configurations, in this case closed rectangular tracks as these are easier to fit on a card alongside a pair of matrices.

### ADVANTAGES

The preferred set of cards allows the operation of a lottery with a small number pool (from 6 to 16 numbers) yet allows the complexity of different numbers of potential links as shown in the odds tables in the drawings.

By producing cards with 2 or more matrices the number of permutations is multiplicative though the number of symbols drawn to complete the lottery remains the same, as the same symbols appear on each matrix—albeit in different locations. In addition by having two or more 3×3 matrices on the card the player cannot have an outcome of no links at all—as the player will always have at least two links or above, which enhances player satisfaction, and the number of near win experiences (where the player achieves a significant number of the required links for a win) is increased, making the game more interesting and tantalising for players.

In particular:
i. the Most Frequently Attained Base Output Level of the Base Game Structure provided by the preferred set of cards may be at a level that is materially greater than in Base Game Structures of some conventional Lotto or Keno type games, and may be at a level that is at least 100% greater, or alternatively, greater by 4 or more Incremental Successes (whichever is the greater); and
ii. there may be an overall and mathematically provable greater level of Incremental Successes; and
iii. a much lower sized number pool may be used, preferably being no greater than 16 numbers, but more preferably, no greater than 9 numbers.

### INDUSTRIAL APPLICABILITY

The set of cards of the invention are typically used in State Lotteries to raise funds for a State Government. They are a tangible and saleable commodity with an interaction between the different cards in a set, as each card in the set contains the same set of symbols but the layout of the symbols on each card is different and hence the number of links achieved by players in a link-lottery will be different. The use of two or more matrices enhances the player engagement by creating numerous “near win” experiences. In enhancing player engagement and hence promoting the popularity of the game provided by the present set of cards, the invention promises to be of significant use in raising funds alongside and/or independently of existing Government-run Lottery schemes and models. A system of storing card information and printing cars on demand is also described, as is the production and use of “scratch to win” cards. The invention can also be used in the manufacture of and form part of casino or slot machines.

### EQUIVALENTS

The Invention may also broadly be said to consist in the parts, elements and features referred or indicated in the specification, individually or collectively, and any or all combinations of any of two or more parts, elements, members or features and where specific integers are mentioned herein which have known equivalents such equivalents are deemed to be incorporated herein as if individually set forth.

The examples and the particular proportions set forth are intended to be illustrative only and are thus non-limiting.

### VARIATIONS

The invention has been described with particular reference to certain embodiments thereof. It will be understood that various modifications can be made to the above-mentioned embodiment without departing from the ambit of the invention. The skilled reader will also understand the concept of what is meant by purposive construction.

1-57. (canceled)

58. A set of cards for a link-lottery wherein each card contains at least two playing areas, each playing area comprising a plurality of adjoining cells, wherein a majority of cells in each playing area have at least 3 adjoining cells, each cell contains a symbol selected from a set of symbols, the symbol in each cell being different from the symbols in the other cells on that playing area, wherein the size of the set of symbols is between 6 and 16 symbols.

59. The set of cards for a link-lottery as claimed in claim 58, wherein each card has provision for displaying or recording the total number of links between adjoining cells in each playing area if the adjoining cells contain symbols which have been drawn or displayed in sequence in the link-lottery.

60. The set of cards for a link-lottery as claimed in claim 59, wherein each card has provision for recording the order in which the symbols have been drawn in the link lottery.

61. The set of cards for a link-lottery as claimed in claim 58, wherein each playing area is matrix of cells.

62. The set of cards for a link-lottery as claimed in claim 61, wherein each of the matrices having a defined layout of at least a subset of a set of symbols, wherein the set of symbols comprises between 6 and 16 different symbols, wherein each symbol in the set of symbols appears no more than once on each matrix, and wherein at least one of the matrices on each card is selected from the group comprising matrices of the following sizes: 2×3; 3×3; 3×4; and 4×4.

63. The set of cards for a link-lottery as claimed in claim 62, wherein the provision on each card for recording the total number of links between adjoining cells comprises designated locations on each card for recording the number of links on each playing area.

64. The set of cards for a link-lottery as claimed in claim 62, wherein each card contains two matrices, each of the matrices being a matrix of 3×3 cells, each cell containing a symbol selected from a set of 9 symbols, the symbol in each cell being different from the symbols in the other cells on that matrix.

65. The set of cards for a link-lottery as claimed in claim 64, wherein each card has provision for displaying or recording links between adjoining cells in each matrix if the adjoining cells contain symbols which have been drawn or displayed in sequence in the link-lottery.

66. The set of cards for a link-lottery as claimed in claim 64, wherein each card in the set differs from each other card in the set by the layout of symbols on each card.

67. The set of cards for a link-lottery as claimed in claim 64, wherein each card also includes instructions for playing the link-lottery game based on a draw of the symbols and the creation of links between symbols in adjoining cells on each matrix on each card, and prize rules setting out the number of links needed to claim a prize.

68. The set of cards for a link-lottery as claimed in claim 64, wherein each card is a scratch card having a removable layer, the symbols on each matrix are hidden under the removable layer, so that the symbols can only be revealed by removing the removable layer.

69. The set of cards for a link-lottery as claimed in claim 64, wherein each card is a scratch card having a removable layer, the draw of the symbols for that card is hidden under the removable layer, so that the draw can only be revealed by removing the removable layer, and the symbols on each matrix are also hidden under the removable layer, so that the symbols can only be revealed by removing the removable layer, allowing the player to check each matrix for links and to score the total number of links on each matrix.

70. The set of cards for a link-lottery as claimed in claim 69, wherein each card also includes at least one machine readable code to enable the player to check the result at a lottery outlet.
